(19) United States
(12) Patent Application Publication
(10) Pub. No.: US 2017/0038897 A1
(43) Pub. Date: Feb. 9, 2017

(54) DISPLAY APPARATUS AND CONTROL METHOD THEREOF

(71) Applicant: SAMSUNG ELECTRONICS CO., LTD., Suwon-si (KR)

(72) Inventors: Jeong-hyun PARK, Suwon-si (KR); Chun-woo PARK, Suwon-si (KR); Jin-sung AN, Suwon-si (KR); Jae Kwang LEE, Suwon-si (KR); Young-ran HAN, Seoul (KR)

(73) Assignee: SAMSUNG ELECTRONICS CO., LTD., Suwon-si (KR)

(21) Appl. No.: 15/227,160

(22) Filed: Aug. 3, 2016

(30) Foreign Application Priority Data
Aug. 3, 2015 (KR) 10-2015-0109739

(51) Int. Cl. G06F 3/041; G06F 3/042; G06F 3/03; G06F 3/044

(52) U.S. Cl. CPC G06F 3/0416; G06F 3/0412; G06F 3/044; G06F 3/0425; G06F 3/0304; G06F 2203/0382; G06F 2203/0331

(57) ABSTRACT

A display apparatus includes a display, a sensor, and at least one processor. The display is configured to display an image. The sensor is configured to sense a touch input on a touch surface, the touch input being caused by at least one touch unit among a plurality of touch units mounted to a user and corresponding to a plurality of preset operations to be performed in the display apparatus. The at least one processor is configured to determine the at least touch unit that causes the touch input sensed by the sensor among the plurality of touch units, and execute an operation which corresponds to the determined at least one touch unit among the plurality of preset operations with respect to the touch input.

### CROSS-REFERENCE TO RELATED THE APPLICATION

This application claims priority from Korean Patent Application No. 10-2015-0109739, filed on Aug. 3, 2015, in the Korean Intellectual Property Office, the disclosure of which is incorporated herein by reference.

### BACKGROUND

Field

Apparatuses and methods consistent with exemplary embodiments relate to a display apparatus, which has an input device for executing a preset operation in response to a touching operation with a user's fingers or the like, and a control method thereof, and more particularly to a display apparatus, which has a structure for executing different operations according to a user's fingers of making a touching operation, and a control method thereof.

Description of the Related Art

A display apparatus is provided with a display panel, and the display apparatus displays an image based on a broadcast signal or a video signal/video data of various formats. The display apparatus may be achieved by a television (TV), a monitor, etc. The display panel is to display an input video signal as an image on its image display surface. There are various types of display panels such as a liquid crystal display (LCD) panel, a plasma display panel (PDP), etc.

The display panel provided in the display apparatus maybe be classified as either a light receiving structure or a self-emissive structure depending on how light for displaying the image is generated. The light receiving structure is a non-emissive structure where the display panel cannot emit light by itself, and thus needs a backlight unit arranged in the back of the display panel to generate the light for illuminating the display panel. For example, an LCD panel has a non-emissive structure. On the other hand, the display panel of a self-emissive structure emits light by itself and thus does not need a separate backlight unit. For example, an organic light emitting diode (OLED) display has a self-emissive structure.

With development of technology and expansion of the users' demand, display apparatuses have been expected to have more functions beyond a simple function of displaying an image. On a basic level, a display apparatus includes a physical button, a remote controller, or like user input unit, and may include a touch screen as a more intuitive input unit. The touch screen is provided in the front surface of the display apparatus, senses a position touched by a user's fingers, a stylus pen, or like touch instrument, converts a sensing result into an electric signal, and determines coordinates of the corresponding position. For example, the touch screen has replaced other input units in mobile phones, tablet computers, laptop computers, and other display apparatuses that require greater mobility, and its applicability has been widely expanded.

Further, the touch screen may be applied even to an electric blackboard system. The electronic blackboard system senses coordinates of a touch on the display panel or screen of the display apparatus, and displays an image corresponding to the sensed coordinates on the corresponding panel or screen. For example, if a user draws a picture by touching the panel with her finger, the display apparatus displays a line along the traces made by the user's touch on the panel, thereby showing the picture drawn by the user.

A conventional touch screen may support multi-touch (i.e., sensing two or more simultaneous touches with two or more fingers or touch instruments, and executing a corresponding operation). However, the conventional multi-touch system merely determines whether or not the panel is touched with multiple touch instruments (i.e., determines whether the touch is a single-touch input or a multi-touch input). In other words, the conventional system does not distinguish between the plurality of touch instruments from one another, and therefore there exists a functional limitation in terms of executing corresponding operations for both single-touch and multi-touch inputs.

### SUMMARY

In accordance with an exemplary embodiment, there is provided a display apparatus including: a display configured to display an image; a sensor configured to sense a touch input on a touch surface, the touch input being performed by at least one touch unit among a plurality of touch units mounted on a user, the plurality of touch units corresponding to a plurality of preset operations to be performed in the display apparatus; and at least one processor configured to determine the at least one touch unit that performs the touch input sensed by the sensor, among the plurality of touch units, and to execute an operation which corresponds to the determined at least one touch unit, among the plurality of preset operations with respect to the touch input. Thus, the display apparatus assigns operations to a user's five fingers irrespective of order, condition, or the like of touching the touch surface with the user's fingers, so that a previously designated operation can be executed corresponding to a user's touch input with a certain finger.

The plurality of touch units may be provided to generate a plurality of electric signals different in level from one another, and the at least one processor may determine the at least one touch unit causing the touch input by assigning an identification (ID) to the touch input according to a level of an electric signal sensed by the sensor. Thus, the display apparatus can easily determine which touch unit generated the touch input, based on level difference of a sensed electric signal.

Each touch unit of the plurality of touch units may include a resonant coil for generating an electromagnetic field having a resonant frequency. Respective resonant coils of the plurality of touch units are different in the resonant frequency from one another, and the at least one processor may assign the ID, which is designated according to the resonant frequency of the electromagnetic field, to the touch input. Thus, the display apparatus may easily distinguish the touching units from one another based on the level difference of the sensed resonant frequency.

Each touch unit of the plurality of touch units may include a capacitor. The capacitors of the plurality of touch units are different in capacitance from one another. The sensor may include a plurality of transmitting wires and a plurality of receiving wires. The plurality of transmitting wires may intersect with the plurality of receiving wires. The sensor may apply a touch sensing voltage to the plurality of transmitting wires, and may sense the touch input based on a voltage change caused by the touch input and output from the plurality of receiving wires.

The at least one processor may assign the ID, which is designated according to an output voltage level drop, to the touch input. Thus, the display apparatus may easily distinguish the touch units from one another based on the difference in the voltage output from the plurality of receiving wires.

A marking, indicating position coordinates on the touch surface, may be formed on the touch surface, and each touch unit of the plurality of touch units may include an infrared sensor for sensing the marking on the touch surface, and a communicator for sending to the at least one processor the position coordinates corresponding to the sensed marking. Thus, the touch unit can easily determine its own position coordinates on the touch surface.

The communicator may transmit an ID number of the communicator together with the position coordinates to the at least one processor, and the at least one processor may assign an ID, which is designated according to the ID number, to the touch input.

The communicator may include a Bluetooth communication module, and the ID number may include the Bluetooth communication module's media access control (MAC) address. Thus, the display apparatus may easily distinguish the touch units from one another, based on the ID number of the communicator of the touching unit.

The touch surface may be formed on the display, and the marking may be formed on a black matrix that divides pixels in the display.

The plurality of touch units may be different in color from one another, the sensor may include a camera for sensing respective colors of the plurality of touch units and respective positions of the plurality of touch units on the touch surface, and the at least one processor may determine the at least one touch unit causing the touch input by assigning an ID, which is designated according to a corresponding color sensed by the camera, to the touch input. Thus, the display apparatus may easily distinguish the touch units from one another, by determining the color of each touching unit.

The at least one processor may send touch input information, which includes information about position coordinates of the touch input and information about determination of the at least one touch unit causing the touch input among the plurality of touch units, to an application while the application for performing an operation corresponding to the touch input is being executed on an operating system. The touch input information may comply with standards supported by the operating system.

The information about the determination of the at least one touch unit may be recorded in one of data fields unrelated to the execution of the application, among a plurality of data fields according to the standards.

The information about the determination of the at least one touch unit may be recorded in a data field associated with azimuth among the plurality of data fields according to the standards. Thus, it is possible to apply the exemplary embodiments to existing standards without devising a new standard in order to transmit the touch input information.

The information about the determination of the at least one touch unit may be recorded in a new data field added to the plurality of data fields according to the standards.

The at least one touch unit may include a housing configured to be placed on a finger of the user; and a signal generator configured to be accommodated in the housing and generate the electric signal.

The housing may be shaped like a ring or a thimble. Thus, the touch units may be individually mounted to a user's fingers.

The plurality of touch units may be formed on areas corresponding to a finger of the user in a base shaped like a glove to be worn by the user, and the display apparatus may further include a circuit element installed in a certain area of the base and driving each touch unit to generate the electric signal.

In accordance with another exemplary embodiment, there is provided a method of controlling a display apparatus. The method may include: sensing a touch input on a touch surface, the touch input caused by at least one touch unit among a plurality of touch units mounted on a user and corresponding to a plurality of preset operations to be performed in the display apparatus; determining the at least one touch unit which causes the touch input, among the plurality of touch units; and executing the operation, which corresponds to the determined touch unit, among the plurality of preset operations with respect to the touch input. Thus, the display apparatus assigns operations to a user's fingers irrespective of order, condition, or the like of touching the touch surface with her fingers, so that a previously designated operation can be executed corresponding to the user's touch input with a certain finger.

In accordance with another exemplary embodiment, there is provided a display apparatus including: a display configured to display an image; a sensor configured to sense an input operation on a preset input surface, the input operation caused by at least one input unit among a plurality of input units corresponding to a plurality of preset functions to be performed in the display apparatus in a state where the plurality of input units are mounted on a user; and at least one processor configured to determine the at least one input unit, which causes the input operation sensed by the sensor, among the plurality of input units, and to execute a function that corresponds to the determined input unit among the plurality of preset functions with respect to the input operation.

The plurality of input units may be provided to be respectively mounted to a plurality of fingers of the user.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 illustrates a display apparatus being touched by a user with one finger according to a first exemplary embodiment;

FIG. 2 illustrates a display apparatus being touched by a user with her two fingers according to a second exemplary embodiment;

FIG. 3 illustrates a display apparatus being touched by a user with her two fingers according to a third exemplary embodiment;

FIG. 4 illustrates a database where corresponding operations are assigned to identifications (IDs) of touch inputs in the display apparatus according to the third exemplary embodiment;

FIG. 5 illustrates IDs respectively assigned to the touch inputs sensed on the display panel in the display apparatus according to the third exemplary embodiment;

FIG. 6 illustrates the IDs respectively assigned to the touch inputs sensed on the display panel in the display apparatus when a user takes all of her fingers, as shown in FIG. 5, off the display panel and touches the display panel again with her fingers;

FIG. 7 is a block diagram of a display apparatus according to a fourth exemplary embodiment;

FIG. 8 is a block diagram of a signal processor in a main device of the display apparatus shown in FIG. 7;

FIG. 9 illustrates an input device for a display apparatus according to a fifth exemplary embodiment;

FIG. 10 is a perspective view of a first touch unit in the input device shown in FIG. 9;

FIG. 11 is a block diagram of the first touch unit in the input device according to the fifth exemplary embodiment;

FIG. 12 is a block diagram showing elements related to touch sensing in the main device of the display apparatus according to the fifth exemplary embodiment;

FIG. 13 illustrates a structure of a digitizer module for sensing a touch position by a digitizer controller according to the fifth exemplary embodiment;

FIG. 14 is a block diagram illustrating a process of determining a touch input corresponding to each of thumb and four fingers in a display apparatus according to the fifth exemplary embodiment;

FIG. 15 illustrates a database of FIG. 14;

FIG. 16 is a flowchart for controlling the display apparatus according to the fifth exemplary embodiment;

FIG. 17 illustrates an exemplary operation where the first touch unit of the input device touches the display and detaches from the display according to a sixth exemplary embodiment;

FIG. 18 illustrates a touch unit of an input device being mounted on a pen according to a seventh exemplary embodiment;

FIG. 19 illustrates an input device according to an eighth exemplary embodiment;

FIG. 20 is a block diagram of the input device according to the eighth exemplary embodiment;

FIG. 21 illustrates an input device according to a ninth exemplary embodiment;

FIG. 22 is a block diagram of an input device according to the ninth exemplary embodiment;

FIG. 23 illustrates an input device according to a tenth exemplary embodiment;

FIG. 24 is a block diagram of an input device according to the tenth exemplary embodiment;

FIG. 25 illustrates an input device according to an eleventh exemplary embodiment;

FIG. 26 is a perspective view of a first touch unit in the input device shown in FIG. 25;

FIG. 27 is a block diagram showing a hierarchical structure of platforms for the display apparatus according to a twelfth exemplary embodiment;

FIG. 28 illustrates a data structure used for storing touch input information according to the twelfth exemplary embodiment;

FIG. 29 illustrates a data structure used for storing touch input information according to a thirteenth exemplary embodiment;

FIG. 30 illustrates an input device according to the thirteenth exemplary embodiment;

FIG. 31 is a partial perspective view of a structure of a touch sensor according to the thirteenth exemplary embodiment;

FIG. 32 illustrates a control structure for the touch sensor according to the thirteenth exemplary embodiment;

FIG. 33 is a graph showing a voltage level output from a receiving wire of the touch sensor according to the thirteenth exemplary embodiment;

FIG. 34 is a flowchart for controlling a display apparatus according to the thirteenth exemplary embodiment;

FIG. 35 illustrates an input device according to a fourteenth exemplary embodiment;

FIG. 36 is a block diagram of a first touch unit according to the fourteenth exemplary embodiment;

FIG. 37 is a sequence diagram for operations between the first touch unit of the input device and the touch sensing processor of the main device according to the fourteenth exemplary embodiment;

FIG. 38 is a lateral cross-section view of a display panel according to a fifteenth exemplary embodiment;

FIG. 39 illustrates a shape of a black matrix according to the fifteenth exemplary embodiment;

FIG. 40 illustrates an input device according to a sixteenth exemplary embodiment;

FIG. 41 illustrates a main device sensing a touch input of a second touch unit according to the sixteenth exemplary embodiment;

FIG. 42 is a block diagram of the main device according to the sixteenth exemplary embodiment;

FIG. 43 illustrates a database according to the sixteenth exemplary embodiment;

FIG. 44 is a flowchart for controlling a display apparatus according to the sixteenth exemplary embodiment;

FIG. 45 illustrates a video game application being executed in a display apparatus according to a seventeenth exemplary embodiment;

FIG. 46 illustrates a database according to the seventeenth exemplary embodiment;

FIG. 47 illustrates a database where combination operations are assigned to multi-touch inputs according to the seventeenth exemplary embodiment;

FIG. 48 illustrates an application being executed in a display apparatus according to an eighteenth exemplary embodiment;

FIG. 49 is a flowchart for controlling the display apparatus according to the eighteenth exemplary embodiment;

FIG. 50 is a flowchart for controlling a display apparatus according to a nineteenth exemplary embodiment;

FIG. 51 illustrates a display apparatus according to a twentieth exemplary embodiment;

FIG. 52 illustrates a default database stored in the display apparatus according to a twenty-first exemplary embodiment; and

FIG. 53 illustrates a user interface (UI), in which operations assigned in the database is changeable, displayed on the display apparatus according to the twenty-first exemplary embodiment.

### DETAILED DESCRIPTION OF EXEMPLARY EMBODIMENTS

Below, exemplary embodiments will be described in detail with reference to accompanying drawings. The following descriptions of the exemplary embodiments are made by referring to elements shown in the accompanying drawings, in which like numerals refer to like elements having substantively the same functions.

In the description of the exemplary embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the idea of the invention.

Further, the exemplary embodiments will describe only elements directly related to the idea of the invention, and description of the other elements will be omitted. However, it will be appreciated that the elements, the descriptions of which are omitted, are not unnecessary to realize the apparatus or system according to the exemplary embodiments. In the following descriptions, terms such as “include” or “have” refer to presence of features, numbers, steps, operations, elements or combination thereof, and do not exclude presence or addition of one or more other features, numbers, steps, operations, elements or combination thereof.

The word “exemplary” is used herein to mean “serving as an example or illustration.” Any aspect or design described herein as “exemplary” is not necessarily to be construed as preferred or advantageous over other aspects or designs. Moreover, it should be understood that features or configurations herein with reference to one embodiment or example can be implemented in, or combined with, other embodiments or examples herein. That is, terms such as “embodiment,” “variation,” “aspect,” “example,” “configuration,” “implementation,” “case,” and any other terms which may connote an embodiment, as used herein to describe specific features or configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Thus, one of ordinary skill in the art will readily recognize that the various embodiments or examples described herein, and their associated features, can be combined with each other.

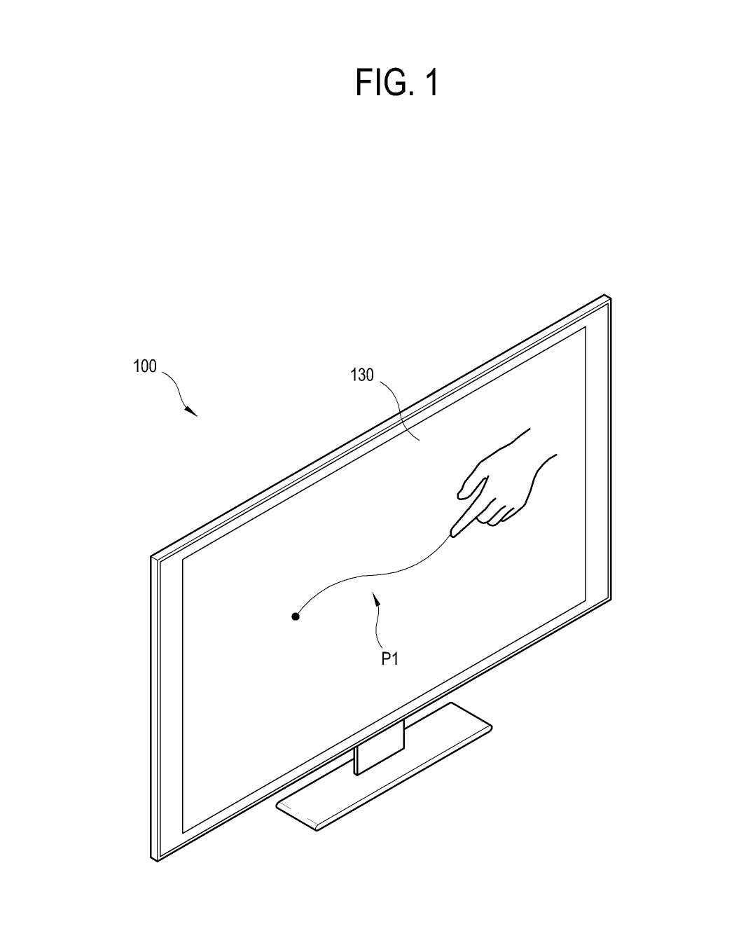

FIG. 1 illustrates a display apparatus 100 being touched by a user with one finger according to a first exemplary embodiment.

As shown in FIG. 1, the display apparatus 100 according to the first exemplary embodiment may be achieved by an electronic blackboard having a touch screen structure. When a user touches a certain position on a display panel 130 with her one finger, the display apparatus 100 senses coordinates of the touched position, and displays an image P1 corresponding to a user's touch at the position corresponding to the sensed coordinates of the display panel 130. In this exemplary embodiment, the display apparatus 100 may be vertically positioned on an installation surface as with a TV or a monitor, or may be a portable device such as a tablet computer or a mobile phone. The display apparatus 100 may also be placed horizontally on a table or a like installation surface.

For example, suppose that a user touches a first position on the display panel 130 with her finger, drags the finger along the surface of the display panel 130, and stops at a second position. In this case, the display apparatus 100 senses change in a user's touch position over time, and displays an image P1 of a connecting line from the first position to the second position along traces of a user's touch.

With this, the display apparatus 100 is capable of displaying the image P1 corresponding to a user's touching operation. In this exemplary embodiment, one touch input is made per unit time because a user touches the display panel 130 with one finger. Such touch input will be hereby referred to as a single touch.

However, the display apparatus 100 may support multiple touches in accordance with structures of a touch screen.

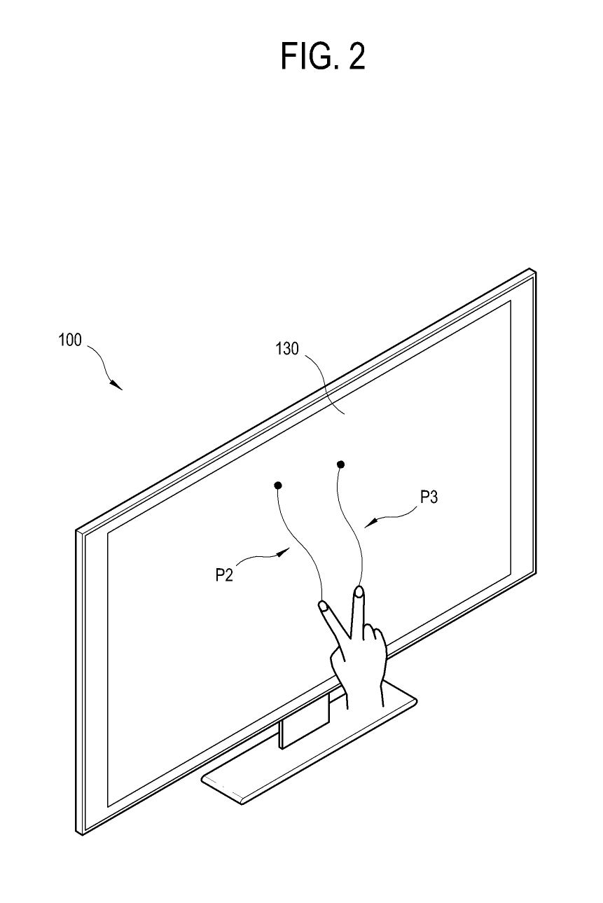

FIG. 2 illustrates a display apparatus 100 being touched by a user with two fingers according to a second exemplary embodiment.

As shown in FIG. 2, a user may drag two of her fingers across the display panel 130. In this case, the display apparatus 100 senses change in a position touched with each of the fingers, and displays an image P2 corresponding to moving traces of a first finger and an image P3 corresponding to moving traces of a second finger on the display panel 130.

In this exemplary embodiment, two touch inputs are made per unit time because a user touches the display panel 130 with two fingers. Such a user's touch inputs (i.e., two or more fingers) will be hereby referred to as multi-touch.

In response to a user's multi-touch input, the display apparatus 100 may respectively sense the touch input based on the first finger and the touch input based on the second finger, but not necessarily distinguish between the former and the latter. That is, the display apparatus 100 displays an image of a solid line corresponding to the touch input of the first finger and displays an image of the same solid line corresponding to the touch input of the second finger, in which two images P2 and P3 have substantially similar attributes.

Thus, the display apparatus 100 may distinguish the touch inputs from one another if a user's multi-touch input is sensed, in accordance with the types of the touch screen, and execute different operations in response to the distinguished touch inputs, respectively.

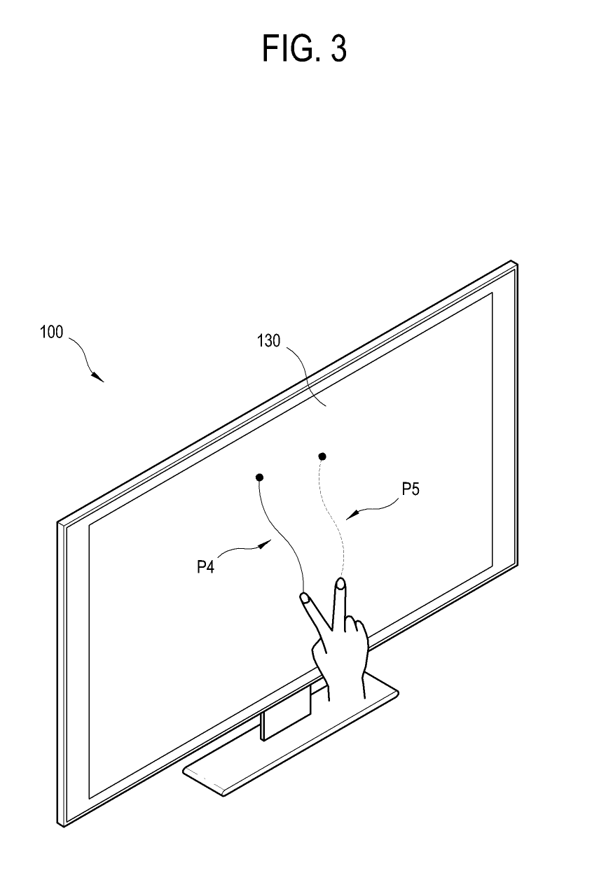

FIG. 3 illustrates a display apparatus 100 being touched by a user with two fingers according to a third exemplary embodiment.

As shown in FIG. 3, a user may drag her two fingers across the display panel 130. The display apparatus 100 distinguishes a touch input of a first finger and a touch input of a second finger, and recalls settings previously determined with regard to each touch input. The display apparatus 100 displays an image P4 corresponding to the touch input of the first finger and an image P5 corresponding to the touch input of the second finger on the display panel 130 in accordance with the predetermined settings for the respective touch inputs.

Such settings for displaying the images P4 and P5 are previously prepared and stored in the display apparatus 100. For example, the display apparatus 100 stores a database where identifications (IDs) about the respective touch inputs and operations corresponding to the respective IDs are assigned. The display apparatus 100 assigns the ID to each touch input when the multi-touch input is sensed, and performs the operation assigned to the corresponding ID.

If two touch inputs are sensed on the display panel 130, the display apparatus 100 assigns an ID to each touch input with respect to a preset reference and checks the operations corresponding to the respective IDs. If the operation corresponding to the first ID is designated as the solid line, the display apparatus 100 displays the image P4 of the sold line corresponding to the first touch input. If the operation corresponding to the second ID is designated as a dotted line, the display apparatus 100 displays the image P5 of the dotted line corresponding to the second touch input.

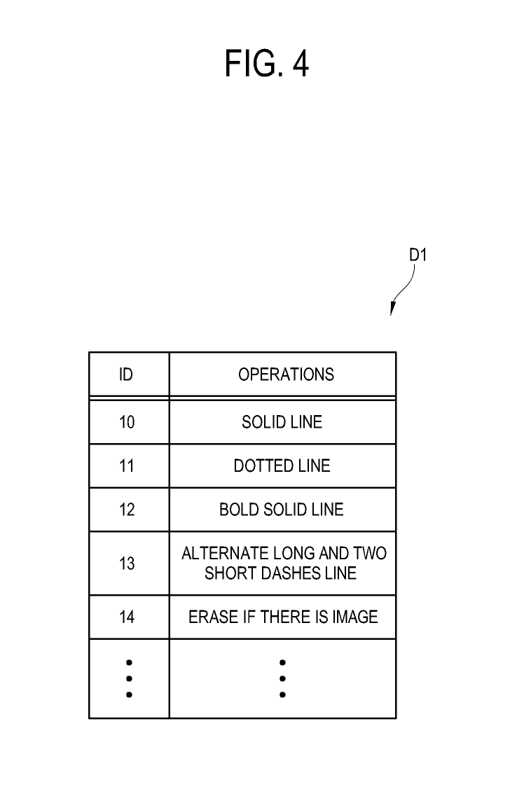

FIG. 4 illustrates a database (DB) D1 where corresponding operations are assigned to identifications or identifiers (IDs) of touch inputs in the display apparatus 100 according to the third exemplary embodiment.

As shown in FIG. 4, the display apparatus 100 includes the DB D1 where IDs for distinguishing the touch inputs and operations to be executed corresponding to the respective IDs are designated. The DB D1 may be designed and applied when the display apparatus 100 is manufactured, or may be set up through a UI by a user.

For example, in the DB D1, the touch input corresponding to the ID of ‘10’ may be designated to display a solid line, and the touch input corresponding to the ID of ‘11’ may be designated to display a dotted line. In this manner, operations corresponding to many touch inputs may be designated in the DB D1. The display apparatus 100 may perform operations corresponding to the respective touch inputs even if there are three or more touch inputs.

Here, there are many methods of how to assign the ID to each touch input, when the display apparatus 100 senses the multi-touch input.

As one example of the methods, the display apparatus 100 may assign the IDs to the respective touch inputs in sequence in order of sensing the touch input on the display panel 130. For instance, the display apparatus 100 assigns the first ID to the first touch input when the first touch input is sensed on the display panel 130. Further, the display apparatus 100 assigns the second ID to the second touch input if the second touch input is sensed while the first touch input is being sensed on the display panel 130.

On the other hand, the display apparatus 100 may assign the first ID to the first touch input if the first touch input is sensed on the display panel 130. Then, if a user takes her finger off the display panel 130 and thus the first touch input is not sensed on the display panel 130 anymore, the display apparatus 100 may release the assignment of the first ID to the first touch input. After that, if the second touch input is sensed on the display panel 130, the display apparatus 100 may reassign the first ID to the second touch input because the second touch input is the only input currently being sensed on the display panel 130.

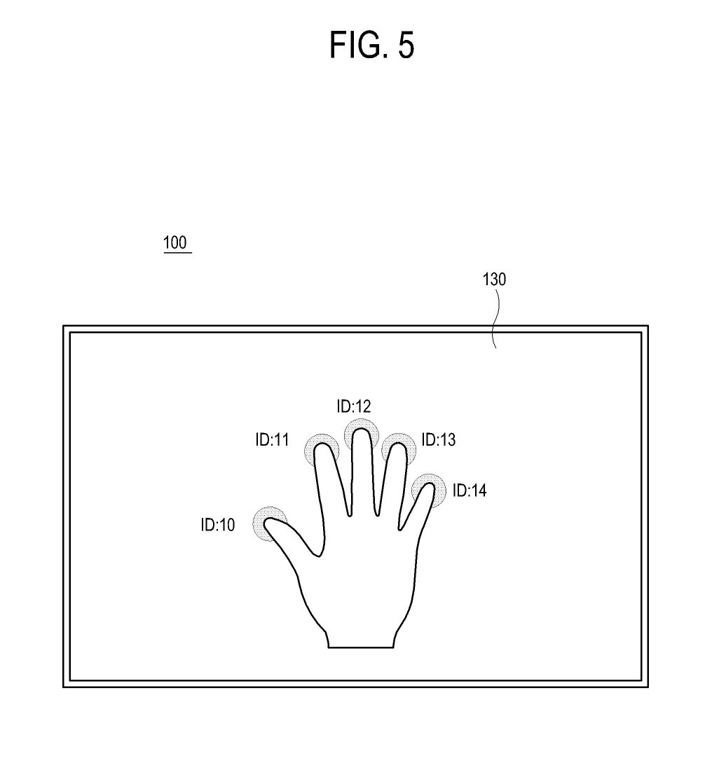

FIG. 5 illustrates IDs respectively assigned to the touch inputs sensed on the display panel 130 in the display apparatus 100 according to the third exemplary embodiment.

As shown in FIG. 5, the display apparatus 100 respectively assigns IDs to a user's five fingers (i.e., digits) when all five fingers are all sensed on the display panel 130. While a user touches the display panel 130 with her thumb and index, middle, ring, and little fingers, the display apparatus 100 respectively assigns the IDs to the five fingers in order of sensing five touch inputs of the fingers on the display panel 130.

For example, suppose that the IDs ‘10,’ ‘11,’ ‘12,’ ‘13,’ and ‘14’ are previously prepared in order, and the display panel 130 is touched by the thumb, the index finger, the middle finger, the ring finger, and the little finger in order. In this case, the display apparatus 100 assigns ‘10’ to the touch input of the thumb, ‘11’ to the touch input of the index finger, ‘12’ to the touch input of the middle finger, ‘13’ to the touch input of the ring finger, and ‘14’ to the touch input of the little finger, in the order that the touch inputs were sensed.

In this exemplary embodiment, the display apparatus 100 assigns the ID to each sensed touch input when multi-touch inputs are received, and the ID given to each touch input is valid while the corresponding touch input is continuously sensed on the display panel 130. That is, the display apparatus 100 need not determine which one of the user's fingers the touch input sensed on the display panel 130 is caused by.

Suppose that the touch input corresponding to one among the five fingers is not sensed on the display panel 130 (i.e. a user lifts one of the five fingers off the display panel 130) after the IDs are respectively assigned to the corresponding touch inputs of the fingers. In this case, the display apparatus 100 invalidates the IDs assigned to the touch inputs caused by the five fingers. For example, if the touch input caused by the index finger is not sensed anymore, the display apparatus 100 resets the ID ‘12’ previously assigned to the corresponding touch input. If the touch inputs caused by all five fingers are no longer sensed, the display apparatus 100 resets all the IDs previously assigned to the five fingers.

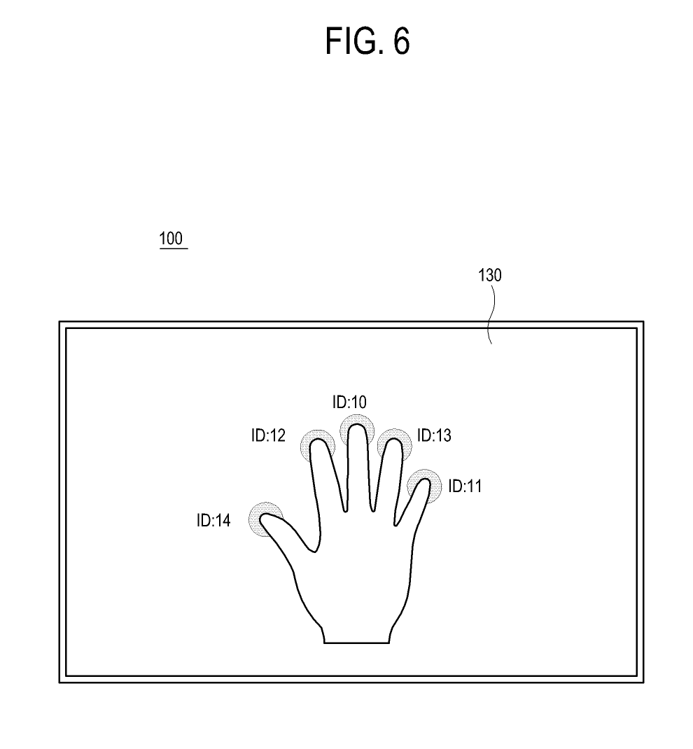

FIG. 6 illustrates the IDs respectively assigned to the touch inputs sensed on the display panel in the display apparatus 100 when a user takes all of her fingers, as shown in FIG. 5, off the display panel 130 and touches the display panel 130 again with five fingers;

When a user takes all of her fingers off the display panel 130 after the IDs were respectively assigned to the five fingers as shown in FIG. 5, the display apparatus 100 invalidates the IDs assigned to the touch inputs of all the fingers. Thereafter, if a user touches the display panel 130 again with her five fingers, the display apparatus 100 assigns the IDs to the respective touch inputs by the five fingers in order the touch inputs were sensed on the display panel 130.

As shown in FIG. 6, suppose that a user touches the display panel 130 with her five fingers in the order of the middle finger, the little finger, the index finger, the ring finger, and the thumb. In the order of the touch inputs, the display apparatus 100 assigns ‘10’ to the touch input caused by the middle finger, ‘11’ to the touch input caused by the little finger, ‘12’ to the touch input caused by the index finger, ‘13’ to the touch input caused by the ring finger, and ‘14’ to the touch input caused by the thumb.

Considering the state shown in FIG. 5 and the state of the FIG. 6 which are shown in continuation temporally, the display apparatus 100 determines only the order of the touch inputs without necessarily determining which touch input is caused by which one of the five fingers. With this structure, the assigned IDs are reset when a user takes her five fingers off the display panel 130, and it is therefore impossible to consistently assign the IDs to specified fingers. In other words, the touch inputs caused by the five fingers may not be associated with their own specific operations because the IDs may be variably assigned to each of the fingers.

According to a general use pattern in light of intuitiveness, a user may expect the touch inputs caused by her fingers to be associated with their respective operations. For example, if a user prefers to draw a line with her index finger on the display panel 130 and erase the line with her thumb, the user may expect this use pattern to apply to other cases.

To reflect this use pattern, the display apparatus 100 has to distinguish each of the five fingers used for the touch inputs from one another. However, the display apparatus 100 in this exemplary embodiment may determine the order in which the touch inputs were received but not necessarily distinguish among the five fingers. Although the display apparatus 100 in this embodiment sets the touch input of the index finger for an operation of drawing a line at a certain stage, the touch input caused by the index finger may be set for an operation of erasing a line at a next stage after resetting the IDs if the touch inputs are received in a different order.

Therefore, according to this particular exemplary embodiment, it may be difficult to reflect and retain a user's preference and use patterns. To resolve this issue, the display apparatus 100 may need elements for distinguishing among the five fingers for the touch inputs. Below, an exemplary embodiment with these elements will be described.

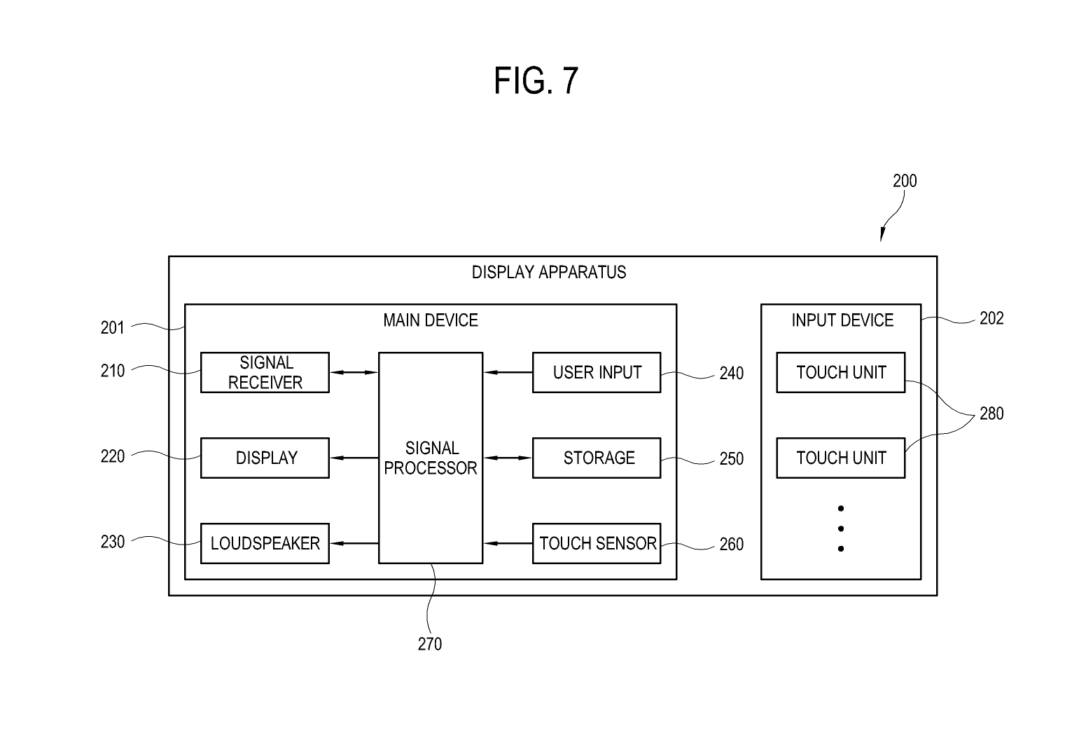

FIG. 7 is a block diagram of a display apparatus 200 according to a fourth exemplary embodiment.

As shown in FIG. 7, the display apparatus 200 according to the fourth exemplary embodiment includes a main device 201 displaying an image, and an input device 202 mounted to a user's hand and used for touching a display 220 of the main device 201. The main device 201 and the input device 202 are physically separated from each other.

The main device 201 includes a signal receiver 210 for receiving a transport stream of video content from the exterior, a display 220 for displaying an image based on video data of the transport stream received in the signal receiver 210, a loudspeaker 230 for generating a sound based on audio data of the transport stream received in the signal receiver 210, a user input 240 for implementing an operation corresponding to a user's input, a storage 250 for storing data, a touch sensor 260 for receiving a touch input of an input device 202 on the display 220, and a signal processor 270 for controlling and calculating general operations of the main device 201.

In addition, the input device 202 includes a plurality of touch units 280 respectively mounted to a user's fingers. The respective touch units 280 may generate different electric signals to be distinguished from one another. Here, the respective touch units 280 may generate the electric signals that may share some of the same characteristics or attributes but may have different levels from one another. Alternatively, the respective touch units 280 may generate electric signals different in characteristics or attributes from one another. That is, there are no limits to the electric signals respectively generated by the touch unit 280 as long as they are distinguishable from one another.

The signal receiver 210 receives a transport stream from various video sources. The signal receiver 210 is not limited to only receiving a signal from an external source, but may transmit a signal to an external device as well, thereby performing interactive communication. The signal receiver 210 may be achieved by an assembly of communication ports or communication modules respectively corresponding to one or more communication standards. The signal receiver 210 may be compatible with various protocols and communication targets. For example, a signal receiver 210 may include a radio frequency integrated circuit (RFIC) for receiving an RF signal, a Wi-Fi communication module for wireless network communication, an Ethernet module for wired network communication, and a universal serial bus (USB) port for local connection with a USB memory or the like.

The display 220 displays an image based on a video signal processed by the signal processor 270. There are no limits to the types of the display 220. For example, the display 220 may be achieved by a non-emissive type such as a liquid crystal display (LCD) or a self-emissive type such as an organic light emitting diode (OLED) display panel. Further, the display 220 may include additional elements in addition to the display panel in accordance with the types of the display panel. For example, if the display 220 is achieved by the liquid crystal display, the display 130 includes a liquid crystal display (LCD) panel, a backlight unit for emitting light to the LCD panel, and a panel driver for driving the LCD panel.

The loudspeaker 230 outputs a sound based on an audio signal processed by the signal processor 270. The loudspeaker 230 vibrates air in accordance with an audio signal and changes air pressure to thereby make a sound. The loudspeaker 230 may include a unit loudspeaker provided corresponding to an audio signal of one channel. In this embodiment, the loudspeaker may include a plurality of unit loudspeakers respectively corresponding to audio signals of the plurality of channels.

There are various kinds of loudspeakers 230 in accordance with frequency bands of a sound to be output. The loudspeakers 230 include, for example, a sub-woofer corresponding to a frequency band of 20 Hz to 99 Hz, a woofer corresponding to a frequency band of 100 Hz to 299 Hz, a mid-woofer corresponding to a frequency band of 300 Hz to 499 Hz, a mid-range speaker corresponding to a frequency band of 500 Hz to 2.9 KHz, a tweeter speaker corresponding to a frequency band of 3 KHz to 6.9 KHz, and a super-tweeter speaker corresponding to a frequency band of 7 KHz to 20 KHz, in which one or more among them are selected and applied to the main device 201.

The user input 240 is an interface that transmits various preset control commands or information to the signal processor 270 in accordance with a user's control or input. The user input 240 transmits various events, which occurs by a user's control in accordance with a user's intention, to the signal processor 270. The input unit 240 may be variously achieved in accordance with information input methods. For example, the input unit 340 may include a button provided on an outer side of the main device 201, a remote controller separated from the main device 201, etc. In this exemplary embodiment, the user input 240 refers to an element corresponding to a user input interface except the touch sensor 260 and the input device 202.

The storage 250 stores various pieces of data under process and control of the signal processor 270. The storage 250 is accessed by the signal processor 270 and performs reading, writing, editing, deleting, updating, or the like with regard to data. The storage 250 is achieved, for example, by a flash memory, a hard disk drive, or the like nonvolatile memory to preserve data regardless of supply of system power in the main device 201.

The touch sensor 260 senses that the display 220 is touched with the respective touch units 280 of the input device 202, and transmits coordinates of a sensed touch position to the signal processor 270. Further, the touch sensor 260 determines IDs of the touch units 280 based on sensed electric signals from the respective touch unit 280, and transmits the determined IDs together with the coordinates to the signal processor 270. The touch sensor 260 may have various elements in accordance with the types of the touch unit 280, and thus details of the touch sensor 260 will be described later.

The signal processor 270 performs various processes with regard to the transport stream received in the signal receiver 210. When the transport stream is received in the signal receiver 210, the signal processor 270 applies video processing to the video signal extracted from the transport stream, and outputs the processed video signal to the display 220 so that an image can be displayed on the display 220.

There is no limit to the kind of video processing performed by the signal processor 270, and the video processing may, for example, include demultiplexing for dividing an input transport stream into sub streams such as a video signal, an audio signal, and additional data, decoding according to video formats of the video signal, de-interlacing for converting video data from an interlaced type into a progressive type, scaling for adjusting a video signal to have a preset resolution, noise reduction for improving image quality, detail enhancement, frame refresh rate conversion, etc.

The signal processor 270 may perform various processes in accordance with the type and properties of a signal or data, and therefore the process of the signal processor 270 is not limited to video processing. Further, the data that can be processed by the signal processor 270 is not limited to data received in the signal receiver 210. For example, the signal processor 270 performs audio processing with regard to an audio signal extracted from the transport stream, and outputs a processed audio signal to the loudspeaker 230. In addition, if a user's speech is input to the main device 201, the signal processor 270 may process the speech in accordance with a preset voice recognition process. The signal processor 270 may be achieved in the form of a system-on-chip (SoC) where various functions corresponding to such processes are integrated, or an image processing board where individual chipset for independently performing the respective processes are mounted to a printed circuit board.

In particular, the signal processor 270 in this embodiment determines an operation previously set to correspond to ID if the ID of the touch input and information about position coordinates are received from the touch sensor 260. Further, the signal processor 270 processes an image corresponding to the information about the position coordinates to be displayed based on the determined operation on the display 220. In addition, the signal processor 270 processes a predetermined application supporting the touch input to be executed based on the information received from the touch sensor 260, on the operating system.

In the display apparatus 200, the main device 201 may have various hardware components in accordance with the types of the main device 201 and the functions supported by the main device 201. For example, a hardware component for tuning to a certain frequency for receiving a broadcast signal may be needed if the main device 201 is a TV, but such hardware component may not be necessary if the main device 201 is a tablet personal computer (PC).

Below, an exemplary signal processor 270 in case where the main device 201 is the TV will be described.

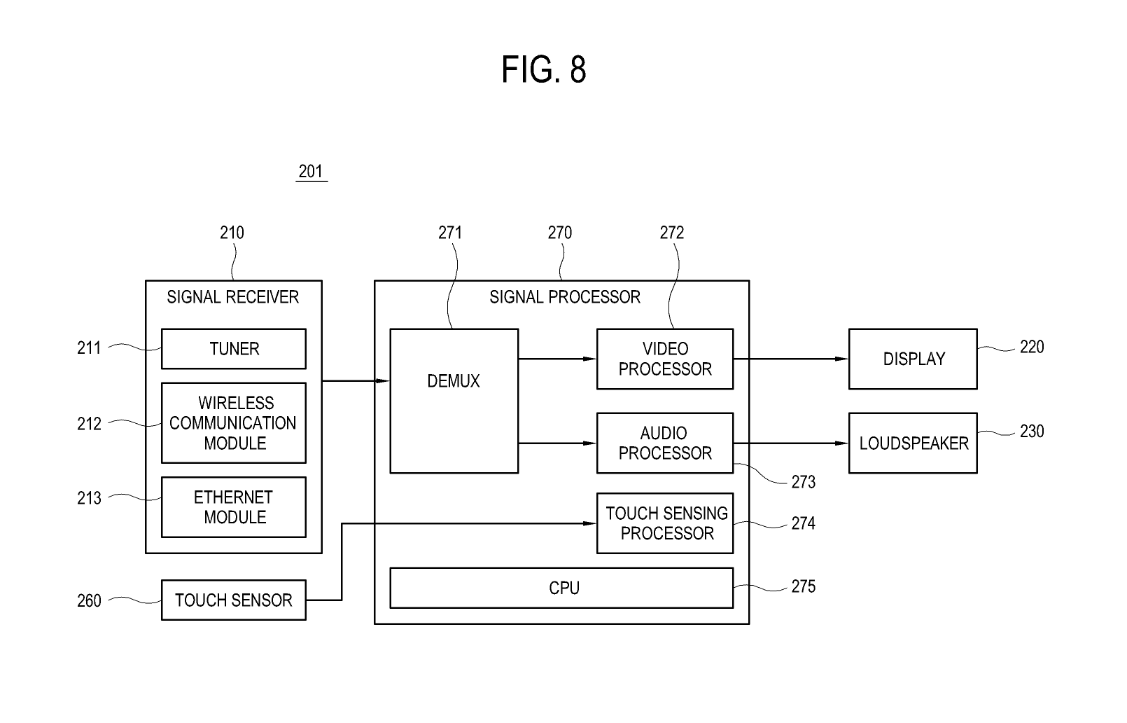

FIG. 8 is a block diagram of the signal processor 270 in the main device 201 of the display apparatus 200 of FIG. 7. FIG. 8 shows only basic elements of the signal processor, and an actual implementation of the main device 201 may include additional elements besides the elements set forth herein.

In this exemplary embodiment, the signal processor 270 is divided into a plurality of processors 272, 273 and 274, but not limited thereto. In practice, such elements may be provided as separate hardware components or may be combined into one or more components. The elements may also be achieved by a combination of hardware and software components.

As shown in FIG. 8, the signal receiver 210 includes a tuner 211 for tuning to a certain frequency to receive a broadcast stream, a wireless communication module 212 for wireless communication, and an Ethernet module 213 for wired communication.

Further, the signal processor 270 includes a demultiplexer (demux) 271, a video processor 272, an audio processor 273, a touch sensing processor 274, and a central processing unit (CPU) 275. The demux 271 may divide the transport stream received from the signal receiver 210 into a plurality of sub-signals. The video processor 272 may process a video signal among the sub-signals output from the demux 271 in accordance with the video processing process, and output the processed video signal to the display 220. The audio processor 273 may process an audio signal among the sub-signals output from the demux 271 in accordance with the audio processing process, and output the processed audio signal to the loudspeaker 230. The touch sensing processor 274 may process touch information received from the touch sensor 260. Further, the CPU 275 may perform calculations and control the operations of the signal processor 270.

When a broadcast stream is received at an RF antenna, the tuner 211 is tuned to a frequency of a designated channel to receive a broadcast stream and converts the broadcast stream into a transport stream. The tuner 211 converts a high frequency of a carrier wave received via the antenna into an intermediate frequency band and converts it into a digital signal, thereby generating a transport stream. To this end, the tuner 211 has an analog/digital (A/D) converter. Alternatively, the A/D converter may be designed to be included in a separate demodulator instead of the tuner 211.

The demux 271 performs a reverse operation of a multiplexer. That is, the demux 271 connects one input terminal with a plurality of output terminals, and distributes a stream input received at the input terminal to the respective output terminals in accordance with selection signals. For example, if there are four output terminals with respect to one input terminal, the demux 271 may select each of the four output terminals by means of a combination of selection signals that may have one of two signal levels (e.g., 0 and 1).

In the case where the demux 271 is applied to the display apparatus 220, the demux 271 divides the transport stream received from the tuner 211 into the sub-signals of a video signal and an audio signal and outputs them through the respective output terminals.

The demux 271 may use various methods to divide the transport stream into the sub-signals. For example, the demux 271 may divide the transport stream into the sub-signals in accordance with packet identifiers (PID) assigned to the packets in the transport stream. The sub-signals in the transport stream are independently compressed and packetized according to channels, and the same PID is given to the packets corresponding to one channel so as to be distinguished from the packets corresponding to another channel. The demux 271 classifies the packets in the transport stream according to the PID, and extracts the sub-signals having the same PID.

The video processor 272 decodes and scales the video signal output from the demux 271 and outputs the processed video signals to the display 220. To this end, the video processor 272 includes a decoder that reverts the video signal back to a state prior an encoding process by performing an opposite process of the encoding process (i.e., decoding) with regard to the video signal encoded by a certain format. The video processor 272 may also include a scaler that scales the decoded video signal in accordance with the resolution of the display 220 or a resolution different from that of the display 220. If the video signal output from the demux 271 is not encoded by a certain format (i.e. not compressed), the decoder of the video processor 272 does not process this video signal.

The audio processor 273 amplifies an audio signal output from the demux 271 and outputs the amplified audio signal to the loudspeaker 230. To this end, the audio processor 273 includes a digital signal supplier for outputting a digital audio signal; a pulse width modulation (PWM) processor for outputting a PWM signal based on a digital signal output from the digital signal supplier, an amplifier for amplifying the PWM signal output from the PWM processor, and an LC filter for filtering the PWM signal amplified by the amplifier by a predetermined frequency band to thereby demodulate the PWM signal.

The touch sensing processor 274 processes the touch input information received from the touch sensor 260 so that an operation can be executed or an image can be displayed corresponding to the processed information. In this exemplary embodiment, the touch sensing processor 274 is provided in the signal processor 270. Alternatively, the touch sensing processor 274 may be provided separately from the signal processor 270 or may be included in the touch sensor 260.

The touch sensing processor 274 specifies a preset operation to correspond to the ID if the ID and the information about coordinates of the touch position are received from the touch sensor 260. Further, the touch sensing processor 274 reflects the specified operations when processing an image to be displayed corresponding to the coordinates of the touch position. The operation specified corresponding to the ID may be based on the database D1 described with reference to FIG. 4.

The CPU 275 is an element for performing calculations to operate elements in the signal processor 270, and plays a central role in parsing and calculating data. The CPU 275 internally includes a processor register in which commands to be processed are stored; an arithmetic logic unit (ALU) being in charge of comparison, determination and calculation; a control unit for internally controlling the CPU 275 to analyze and carry out the commands; an internal bus; a cache (not shown); etc.

The CPU 275 performs calculations needed for operating the elements of the signal processor 270, such as the demux 271, the video processor 272, the audio processor 273, and the touch sensing processor 274. Alternatively, some elements of the signal processor 270 may be designed to operate without the data calculation of the CPU 275 or operate by a separate microcontroller.

Below, details of the input device 202 (see FIG. 7) and the touch sensor 260, which can be achieved by various structures, will be described.

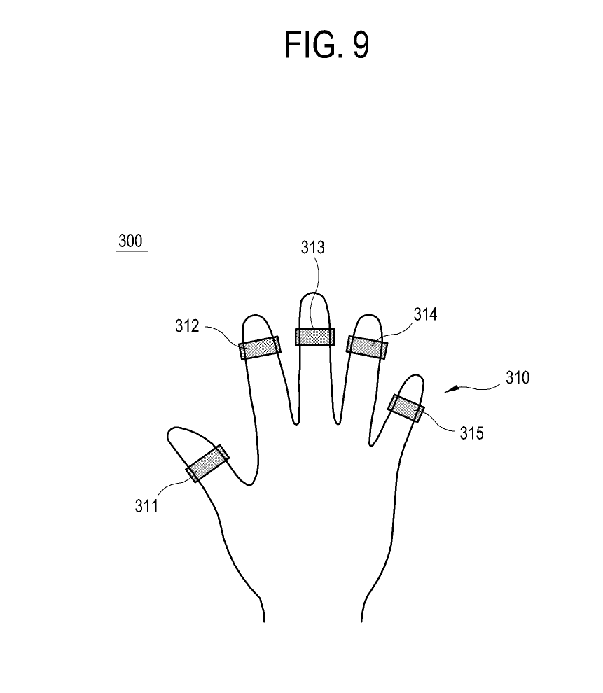

FIG. 9 illustrates an input device 310 for a display apparatus 300 according to a fifth exemplary embodiment.

As shown in FIG. 9, the input device 310 according to the fifth exemplary embodiment includes a plurality of touch units 311, 312, 313, 314, and 315 to be respectively mounted to a user's five fingers. In this exemplary embodiment, there are five touch units 311, 312, 313, 314, and 315 corresponding to a user's fingers. However, the touch units 311, 312, 313, 314, and 315 do not have to respectively correspond to all of the fingers. Alternatively, there may be two, three, or four touch units. The number of touch units may exceed five if more than one hand is to be used. In other words, there are no limits to the number of touch units 311, 312, 313, 314, and 315.

The touch units 311, 312, 313, 314, and 315 are each shaped like a ring, and thus put on a user's fingers. The touch units 311, 312, 313, 314, and 315 include a first touch unit 311 to be put on the thumb, a second touch unit 312 to be put on the index finger, a third touch unit 313 to be put on the middle finger, a fourth touch unit 314 to be put on the ring finger, and a fifth touch unit 315 to be put on the little finger.

In this exemplary embodiment, the touch units 311, 312, 313, 314, and 315 are similar to one another in terms of their basic structures and operating principles. However, the touch units 311, 312, 313, 314, and 315 have structures to be distinguished among them, and details thereof will be described later.

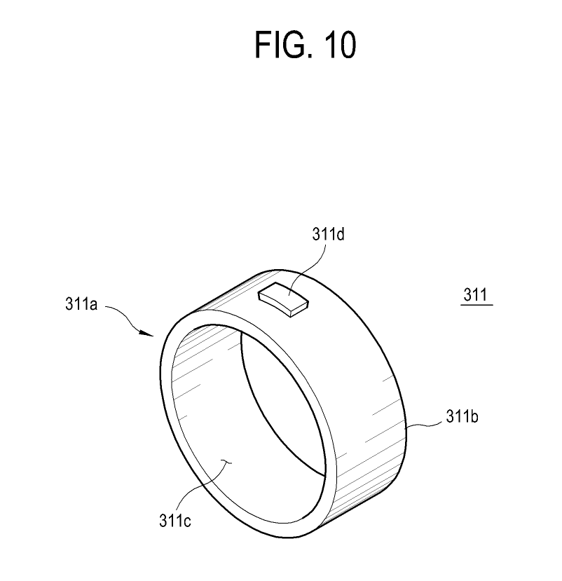

FIG. 10 is a perspective view of a first touch unit 311 in the input device shown in FIG. 9.

As shown in FIG. 10, the first touch unit 311 includes a housing 311a shaped like a ring. The housing 311a has an inner space in which circuit elements of the first touch unit 311 to be described later are accommodated.

In the state that the first touch unit 311 is mounted to a user's finger, an outer surface 311b of the housing 311a has an area that facilitates a contact with the display when a user touches the display while wearing the touch unit 311. An inner surface 311c of the housing 311a forms a space for receiving a user's finger inside the housing 311a.

On the outer surface 311b of the housing 311a, a switch 311d is provided to be toggled by a user. The switch 311d is provided to turn on and off the circuit elements of the first touching unit 311, and may be variously achieved by a mechanical switch, an electronic switch, etc. That is, a user may control the switch 311d to activate or deactivate the internal circuit of the first touch unit 311. Thus, a user controls the switch 311d to turn off the first touch unit 311 while the first touch unit 311 is not in use, thereby preventing wasteful consumption of battery power of the first touch unit 311.

If a user is to manually turn on the switch 311d and uses the first touch unit 311, the switch 311d is preferably placed in an area on the outer surface 311b of the housing 311a, except for an area for touching the display.

Alternatively, the switch may be designed as a pressure sensing type instead of the toggle type. In this alternative case, the switch may be placed in an area on the outer surface 311b of the housing 311a, for touching the display, and details thereof will be described later.

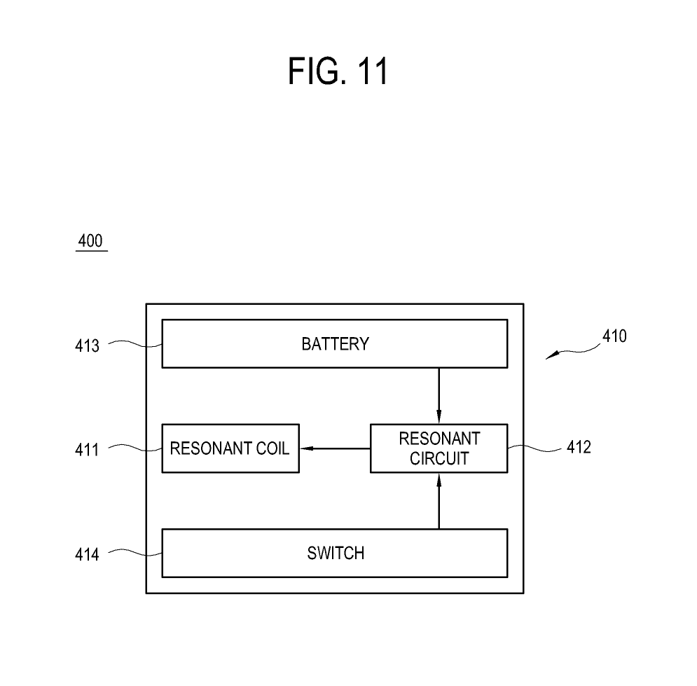

FIG. 11 is a block diagram of a first touch unit 410 in an input device 400 according to the fifth exemplary embodiment. In this exemplary embodiment, the first touch unit 410 is substantially similar to the first touch unit 311 shown in FIGS. 9 and 10.

As shown in FIG. 11, the first touch unit 410 includes a resonant coil 411 for generating an electromagnetic field having a preset resonant frequency, a resonant circuit 412 for driving the resonant coil 411 to generate the electromagnetic field by applying power to the resonant coil 411, a battery 413 for supplying the power, and a switch 414 for controlling the power to be selectively supplied to the resonant coil 411 and the resonant circuit 412.

The resonant coil 411 is accommodated in the housing of the first touching unit 410, and placed near the area for touching the display. However, there are no limits to the placement of the resonant coil 411. The resonant coil 411 may be placed anywhere within the first touch unit 410 as long as the electromagnetic field generated by the resonant coil 411 can be sensed by the display apparatus. That is, the display apparatus senses the touch position by detecting the electromagnetic field generated by the resonant coil 411, and it is therefore not important whether or not the first touch unit 410 touches the display apparatus as long as the touch sensor of the display apparatus senses the electromagnetic field of the resonant coil 411. In other words, the first touch unit 410 does not have to touch the display as long as the resonant coil 411 comes within a range where the electromagnetic field is sensed by the touch sensor.

The resonant coil 411 is achieved by a coil to generate the electromagnetic field having a preset resonant frequency when the resonant circuit 412 operates. Here, the resonant frequency of the electromagnetic field generated by the resonant coil 411 of the first touching unit 410 is different from the resonant frequencies of the electromagnetic fields respectively generated by the other touch units of the input device 400, and details thereof will be described later.

The resonant circuit 412 drives the resonant coil 411 with power supplied from the battery 413 so that the resonant coil 411 can generate the electromagnetic field. The resonant circuit 412 may include various circuit elements such as an oscillator to continue the electromagnetic field of the resonant coil 411. The resonant circuit 412 is turned on or off by the switch 414.

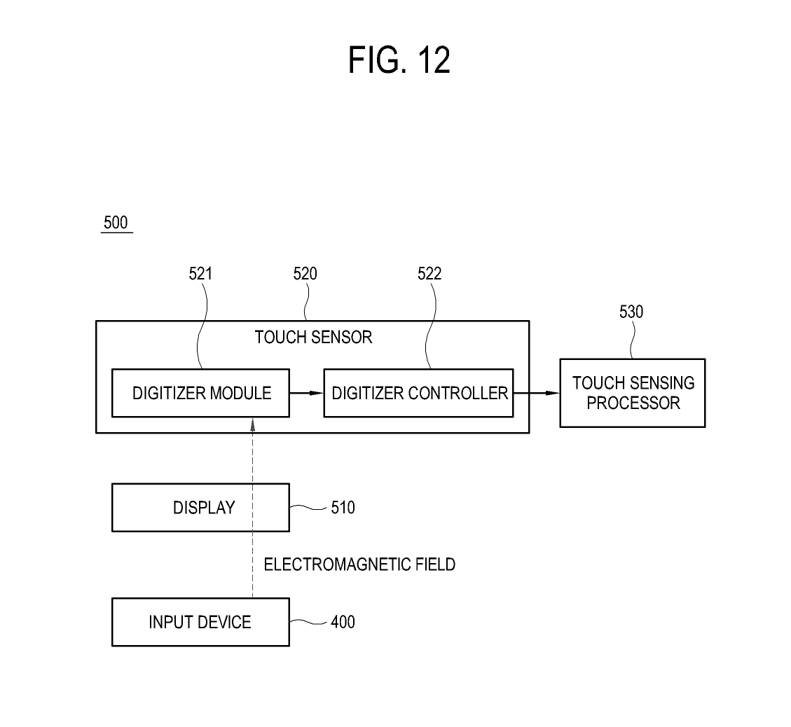

FIG. 12 is a block diagram showing elements related to touch sensing in a main device 500 of the display apparatus according to the fifth exemplary embodiment. FIG. 12 shows only those elements used for sensing the touch input of the input device 400 in the elements of the main device 201 shown in FIG. 8, and thus other basic elements of the main device 500 are substantially similar to those of the foregoing descriptions.

As shown in FIG. 12, the main device 500 of the display apparatus according to the fifth exemplary embodiment includes a touch sensor 520 for sensing the touch input of the input device 400 and outputting the touch input information about the sensed touch input, and a touch sensing processor 530 for processing the touch input information output from the touch sensor 520.

The touch sensor 520 includes a digitizer module 521 for sensing an electromagnetic field generated by the input device 400, and a digitizer controller 522 for generating and outputting the touch input information based on the sensing result of the digitizer module 521.

The digitizer module 521 senses an electromagnetic field generated by each touch unit of the input device 400, and transmits a sense signal based on the sensing result to the digitizer controller 522. Because an object touched by a user with the input device 400 is the display 510 of the main device 500, the digitizer module 521 may be shaped like a flat plane in parallel with the surface of the display 510.

There are no limits to the placement of the digitizer module 521 as long as the digitizer module 521 can sense the electromagnetic field of the input device 400. For example, if the display 510 has a structure of an LCD panel, the digitizer module 521 may be placed at the back of the backlight unit that illuminates the LCD panel and in parallel with the LCD panel. That is, the backlight unit may be interposed between the digitizer module 521 and the LCD panel, thereby avoiding interference with the digitizer module 521 when light travels from the backlight unit to the LCD panel.

The digitizer controller 522 derives coordinates of a position, where the electromagnetic field of the input device 400 is sensed, on the display or the digitizer module 521 in accordance with the sense signal received from the digitizer module 521, and a resonant frequency of the electromagnetic field sensed at the corresponding position. The digitizer controller 522 determines the ID corresponding to the derived resonant frequency, and transmits information about the determined ID and the position coordinates to the touch sensing processor 530.

Below, a method of sensing the touch position of the input device 400 by the digitizer controller 522 will be described.

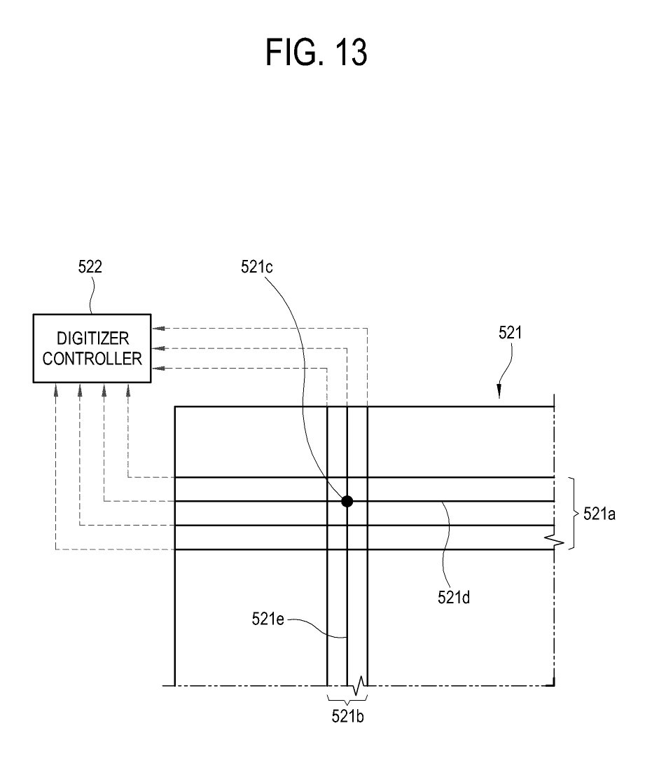

FIG. 13 illustrates a structure of the digitizer module 521 for sensing a touch position by the digitizer controller 522 according to the fifth exemplary embodiment.

As shown in FIG. 13, if at least one among the touch units of the input device comes in contact with the display, the corresponding electromagnetic field of the touch unit is sensed at a certain area of the digitizer module 521.

The digitizer module 521 includes a plurality of horizontal wiring lines 521a and a plurality of vertical wiring lines 521b. The plurality of horizontal wiring lines 521a and the plurality of vertical wiring lines 521b are perpendicular to each other to form a lattice pattern on the plane of the digitizer module 521. FIG. 13 shows some lines of the horizontal wiring lines 521a and the vertical wiring lines 521b, but the horizontal wiring lines 521a and the vertical wiring lines 521b are formed throughout the entire plane of the digitizer module 521. The horizontal wiring lines 521a and the vertical wiring lines 521b are electrically connected to the digitizer controller 522.

Power is not separately supplied to the horizontal wiring lines 521a and the vertical wiring lines 521b. In this state, if a user touches a certain position on the display with the touching unit of the input device, a certain area 521c of the digitizer module 521 corresponding to the touched position is affected by the electromagnetic field of the touching unit. Therefore, an electric current flows in one of the horizontal wiring lines 521a and one of the vertical wiring lines 521b, each of which corresponding to the region 521c, among the entirety of the horizontal wiring lines 521a and the vertical wiring lines 521b.

The electric current flowing in the single horizontal wiring line and the single vertical wiring line is input to the digitizer controller 522. The digitizer controller 522 identifies in a horizontal wiring lines 521d and a vertical wiring lines 521e, in which the electric current flows, among the entirety of the horizontal wiring lines 521a and the vertical wiring lines 521b, and derives the coordinates at the position touched with the touching unit from the identified horizontal and vertical wiring lines.

Further, the digitizer controller 522 determines the resonant frequency of the electromagnetic field based on the characteristic or level of the input current, and thus identifies the ID of the touching unit of the input device based on the determined resonant frequency.

In this exemplary embodiment, the sensed area 521c is illustrated as a dot and covers one horizontal wiring line 521d and one vertical wiring line 521e. However, this is a simplified illustration for the sake of simplicity and clarity. In practice, the sensed area 521c may correspond to an area having a predetermined extent in accordance with the respective pitch levels of the horizontal wiring lines 521a and the vertical wiring lines 521b, and the sensed area 521c may cover a plurality of horizontal wiring lines 521a and a plurality of vertical wiring lines 521b.

With this structure of the display apparatus, a method of determining the touch inputs caused by a user's fingers, and executing operations in accordance with the determined results will be described below.

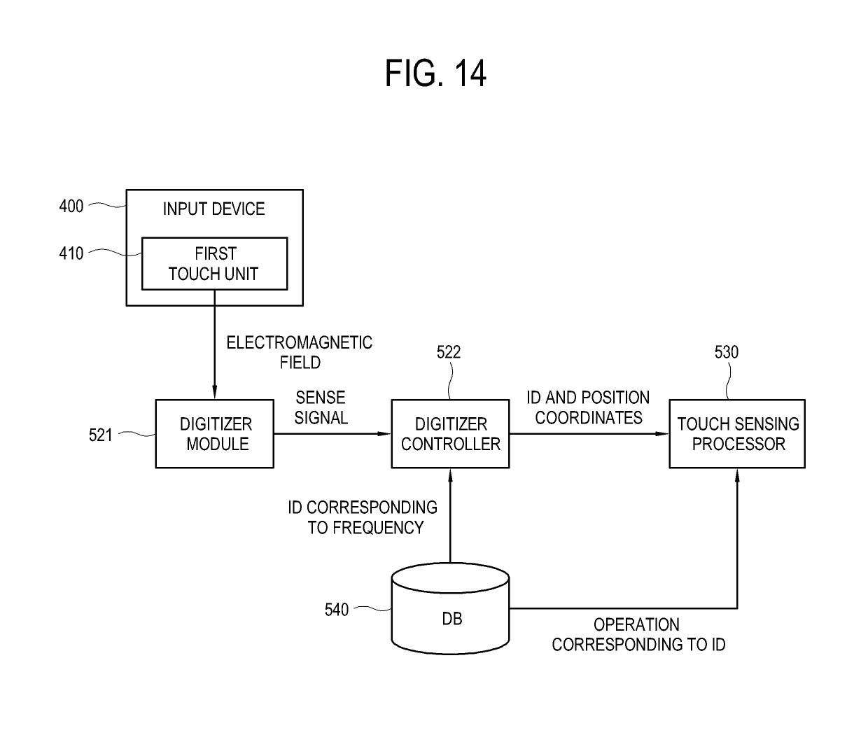

FIG. 14 is a block diagram illustrating a process of determining a touch input corresponding to each of the five fingers in a display apparatus according to the fifth exemplary embodiment,

As shown in FIG. 14, suppose that the touch input is caused by the first touch unit 410 among the plurality of touch units of the input device 400. The first touch unit 410 applies the electromagnetic field. The digitizer module 521 senses the electromagnetic field of the first touch unit 410 and outputs a sense signal.

The digitizer controller 522 derives two pieces of information from the sense signal output from the digitizer module 521, one of which is information about the position coordinates where the touch input is caused by the first touch unit 410, and the other one is the resonant frequency of the electromagnetic field applied by the first touch unit 410.

The digitizer controller 522 searches for the ID corresponding to the derived resonant frequency from a database 540. In the database 540, a plurality of resonant frequencies, IDs respectively corresponding to the resonant frequencies, and operations or functions respectively corresponding to the IDs are previously assigned, details of which will be described later. The digitizer controller 522 transmits the derived information about the position coordinates and ID to the touch sensing processor 530.

The touch sensing processor 530 searches the database 540 for the function corresponding to the ID received from the digitizer controller 522. The touch sensing processor 530 executes the function found in the database 540 in accordance with the search results, and processes an image to be displayed based on the executed function.

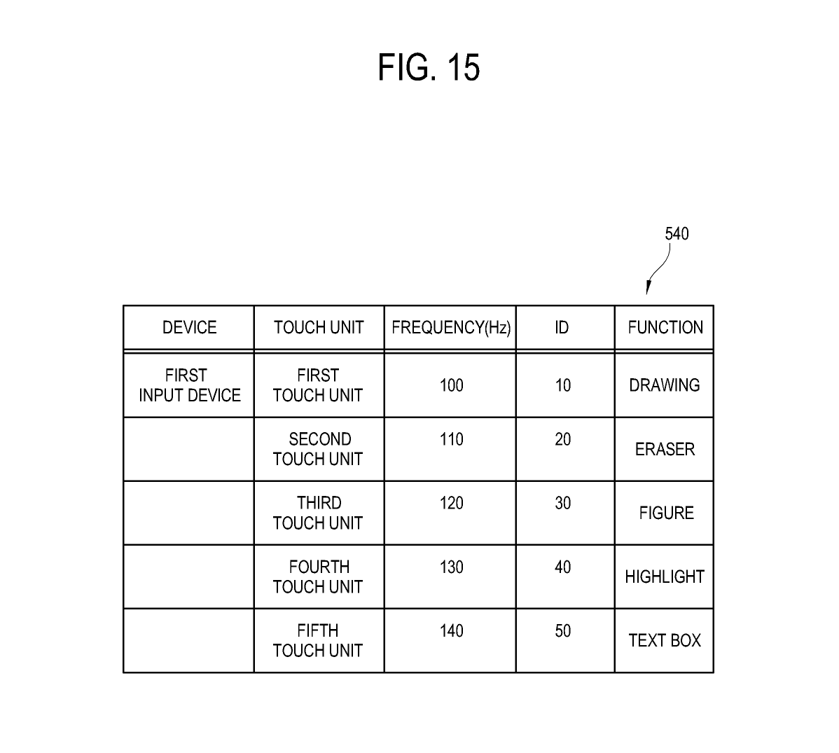

FIG. 15 illustrates the database 540 of FIG. 14.

As shown in FIG. 15, the database 540 records the resonant frequencies of the electromagnetic fields respectively applied by the first touch unit, the second touch unit, the third touch unit, the fourth touch unit, and the fifth touch unit of the first input device. Further, the database 540 records IDs assigned to the respective resonant frequencies, and functions mapped to the respective IDs.

The display apparatus searches the database 540 for the sensed resonant frequency to derive (i.e., identify) the mapped ID, and executes the function assigned to the derived ID. If a user puts the touch units on her fingers and generates touch inputs, the display apparatus can respectively assign the functions to the user's fingers and execute the assigned functions.

Further, a user has only to exchange the touch units among the five fingers, in order to easily change a function assigned to a certain finger to a function of another one. In this manner, a user may conveniently use and change different functions.

For example, if a resonant frequency of 100 Hz is sensed in association with a certain touch input, the display apparatus assigns ID of ‘10’ to the touch input and executes a drawing function corresponding to the ID of ‘10’ in response to the touch input. Likewise, if a resonant frequency of 130 Hz is sensed in association with a certain touch input, the display apparatus assigns ID of ‘40’ to the touch input and executes a text highlighting function corresponding to the ID of ‘40’.

In this exemplary embodiment, as a method of distinguishing among a user's fingers, the touch units respectively mounted to the five fingers may be different in resonant frequency from one another. In this state, the display apparatus senses the resonant frequency of the touch input and thus determines which one of the touch units generated the touch input.

The database 540 shows exemplary settings for the touch units of only the first input device. However, the database 540 may include settings for two or more input devices. In this case, the input devices are different in frequency of the touch units and thus distinguishable from each other.

For example, as shown in the database 540, the touch units of the first input device respectively have the resonant frequencies of 100 Hz, 110 Hz, 120 Hz, 130 Hz, and 140 Hz. On the other hand, the touch units of a second input device may respectively have resonant frequencies of 160 Hz, 170 Hz, 180 Hz, 190 Hz, and 200 Hz by way of example so as to be distinguishable among themselves and also from those of the first input device. Moreover, the touch units of the third input device may respectively have resonant frequencies of 105 Hz, 115 Hz, 125 Hz, 135 Hz, and 145 Hz by way of example so as to be distinguishable from those of the first input device and the second input device. However, the foregoing numerical values are mere examples, and may be variously modified in practice.

In these examples, if the resonant frequency of 110 Hz is sensed, the display apparatus determines that the touch input is caused by the second touch unit of the first input device. Further, if the resonant frequency of 190 Hz is sensed, the display apparatus determines that the touch input is caused by the fourth touch unit of the second input device. In addition, if the resonant frequency of 105 Hz is sensed, the display apparatus determines that the touch input is caused by the first touch unit of the third input device. In this manner, the touch inputs are distinguishable according to the input devices, so that the display apparatus can execute operations respectively designated corresponding to the input devices.

Below, a method of controlling the display apparatus in this exemplary embodiment will be described.

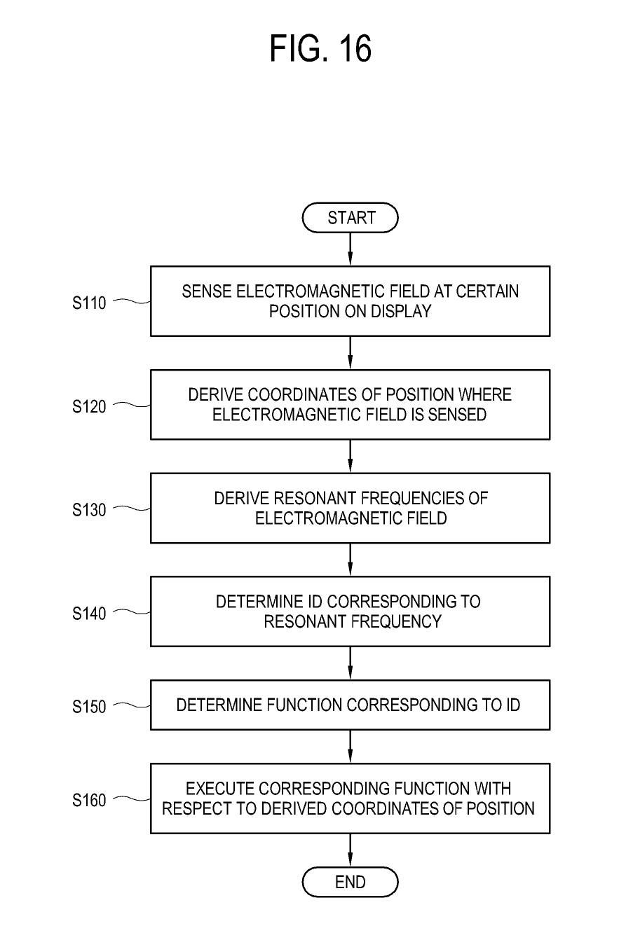

FIG. 16 is a flowchart for controlling the display apparatus according to the fifth exemplary embodiment.

As shown in FIG. 16, at operation S110, the display apparatus senses an electromagnetic field at a certain position on the display. Here, the electromagnetic field is applied by the touch unit of the input device.

At operation S120, the display apparatus derives coordinates of the position where the electromagnetic field is sensed.

At operation S130, the display apparatus derives a resonant frequency of the electromagnetic field.

At operation S140, the display apparatus determines the ID corresponding to the derived resonant frequency.

At operation S150, the display apparatus determines an operation or function corresponding to the determined ID.

At operation S160, the display apparatus executes the determined function with respect to the derived position coordinates, thereby displaying an image.

Thus, the display apparatus distinguishes among a user's fingers for the touch input, and performs a designated function according to the touch input caused by each of the fingers.

In this exemplary embodiment, the display apparatus senses the electromagnetic field of one touch unit among the plurality of touch units of the input device, but the display apparatus is not limited thereto. Alternatively, the display apparatus may simultaneously sense the electromagnetic fields of two or more touching units. This may be achieved by individually sensing and processing the respective touch units, and therefore the foregoing embodiment of sensing one touch unit is applicable to this case. Thus, duplicative descriptions will be reproduced herein.

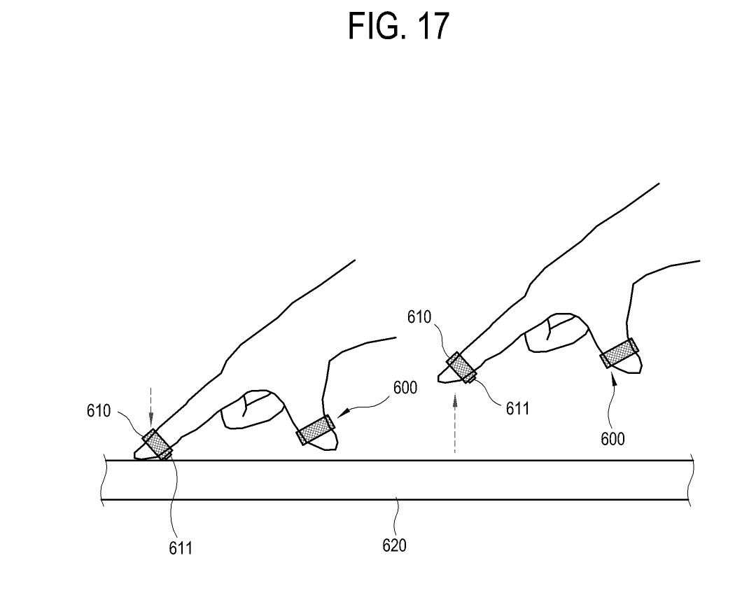

FIG. 17 illustrates an exemplary operation where a first touch unit 610 of an input device 600 touches the display 620 and detaches from the display 620 according to a sixth exemplary embodiment.

As shown in FIG. 17, a user puts the first touch unit 610 on one of her five fingers and touches the display 620 with a certain area on the outer surface of the first touch unit 610. Here, a switch 611 for turning on/off the internal circuit of the first touch unit 610 is provided on the area of the first touch unit 610 for touching the display 620. When a user touches the display 620 with the first touch unit 610, the switch 611 is pressed and thus turns on the internal circuit of the first touch unit 610.

When the internal circuit of the first touch unit 610 is activated by the switch 611, an electric field is generated by power from a battery so that the touch input of the first touch unit 610 can be sensed. The electromagnetic field is continuously activated while the user is touching the display 620 with the first touch unit 610 (i.e. while the switch 611 is pressed against the display 620).

On the other hand, when the user takes the first touch unit 610 off the display 620, the switch 611 is released from the pressure. Thus, the internal circuit of the first touching unit 610 gets deactivated, and the electromagnetic field is no longer generated by the first touch unit 610.

In this manner, it is possible to selectively activate or deactivate the first touch unit 610 in response to the use of the first touch unit 610 even if the user does not intentionally control the switch 611.

In the foregoing exemplary embodiment, the touch units of the input device are respectively mounted to a user's fingers. However, the placement of the touch unit is not limited to the user's fingers.

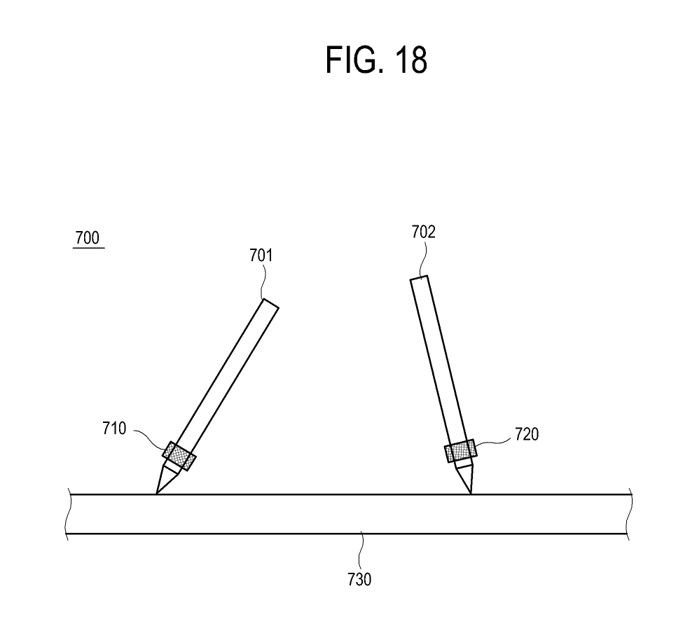

FIG. 18 illustrates touch units 710 and 720 of an input device 700 being mounted on pens 701 and 702 according to a seventh exemplary embodiment.

As shown in FIG. 18, the input device 700 according to the seventh exemplary embodiment includes a plurality of touching units 710 and 720. Each of the touching units 710 and 720 has structures substantially similar to those of the foregoing embodiments, and thus duplicative descriptions thereof will not be reproduced herein.

A user may put one among the plurality of touch units 710 and 720 of the input device 700 on the pen 701 or 702. Since the touch input is sensed based on the electromagnetic field generated by the touch units 710 and 720, the pens 701 and 702 do not have to include any particular circuit structure.

For example, a user may place the first touch unit 710 on the first pen 701, and place the second touch unit 720 on the second pen 702. In this state, if a user touches the display 730 with the first pen 701, the touch input is sensed based on the electromagnetic field of the first touch unit 710. Likewise, if a user touches the display 730 with the second pen 702, the touch input is sensed based on the electromagnetic field of the second touch unit 720. The touch input of the first pen 701 and the touch input of the second pen 702 may be generated on separate occasions from each other or generated concurrently. In both cases, the method of sensing the touch input may be achieved by applying those of the foregoing exemplary embodiments, and thus duplicative descriptions thereof will not be reproduced herein.

In the fifth exemplary embodiment, a battery is individually provided to each touch unit of the input device (see FIG. 11). However, placing batteries in individual touch units may make the touch units relatively bulkier and heavier. Thus, the batteries supplying power to the respective touch units may be centralized in order to reduce the weight and volume of each touch unit.

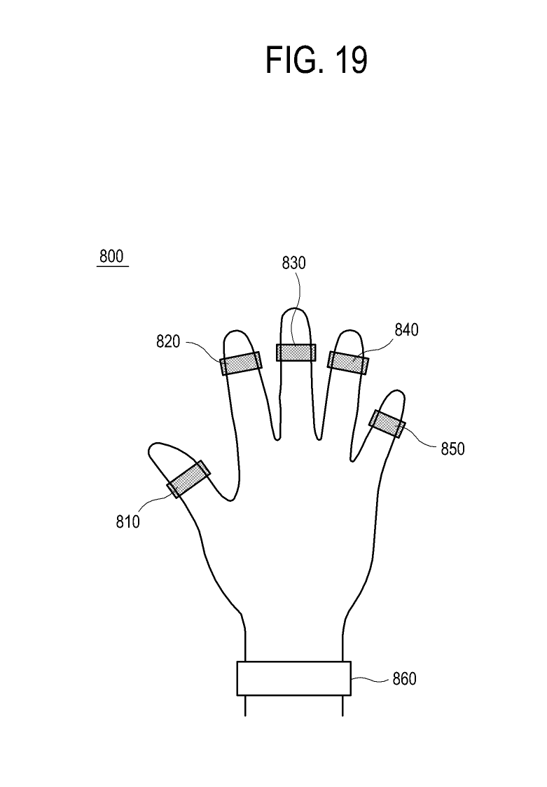

FIG. 19 illustrates an input device 800 according to an eighth exemplary embodiment.

As shown in FIG. 19, the input device 800 according to the eighth exemplary embodiment includes a plurality of touch units 810, 820, 830, 840, and 850 respectively mounted to a user's five fingers, and a main unit 860 for driving the plurality of touch units 810, 820, 830, 840, and 850.

The plurality of touch units 810, 820, 830, 840, and 850 are each shaped like a ring and respectively placed on a user's fingers. The plurality of touch units 810, 820, 830, 840, and 850 respectively generate preset electromagnetic fields. The electromagnetic fields respectively generated by the touch units 810, 820, 830, 840, and 850 are different in resonant frequency from one another within one input device 800. Thus, the touch inputs caused by the touch units 810, 820, 830, 840, and 850 of the input device 800 are distinguishable from one another.

The main unit 860 is placed within a preset distance range from the plurality of touch units 810, 820, 830, 840, and 850 when the input device 800 is used. For example, the main unit 860 may be shaped like a bracelet and put on a user's wrist. The main unit 860 controls individual operations of the touch units 810, 820, 830, 840, and 850, and supplies power for driving the touch units 810, 820, 830, 840, and 850.

The main unit 860 has to be placed within the preset distance range from each of the touch units 810, 820, 830, 840, and 850 in order to wirelessly supply power to the respective touching units 810, 820, 830, 840, and 850. That is, there may be a technical limit to a distance within which the power can be wirelessly supplied, and therefore the main unit 860 needs to be placed within an allowable range so as to wirelessly supply power to the touch units 810, 820, 830, 840, and 850.

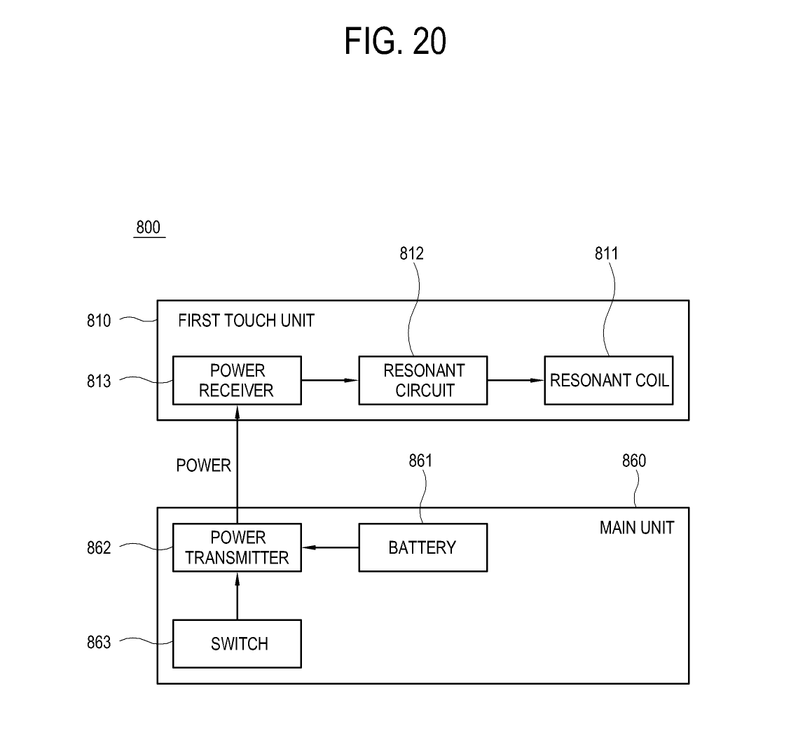

FIG. 20 is a block diagram of the input device 800 according to the eighth exemplary embodiment.

As shown in FIG. 20, the input device 800 includes the main unit 860, and the first touch unit 810 operating with power wirelessly received from the main unit 860. FIG. 20 shows only the first touch unit 810 among the plurality of touch units 810, 820, 830, 840, and 850 (see FIG. 19). The structures of the other touch units 820, 830, 840, and 850 (see FIG. 19) may be achieved by applying that of the first touch unit 810, and thus duplicative descriptions thereof will not be reproduced herein.

The first touch unit 810 includes a resonant coil 811 for generating an electromagnetic field, a resonant circuit 812 for driving the resonant coil 811 with the supplied power, and a power receiver 813 for receiving power wirelessly from the main unit 860 and supplying it to the resonant circuit 812. The resonant coil 811 and the resonant circuit 812 are substantially similar to those of the foregoing exemplary embodiments.

The main unit 860 includes a battery 861 for supplying the power, a power transmitter 862 for wirelessly transmitting the power received from the battery 861 to the first touch unit 810, and a switch 863 for selecting whether to transmit the power from the power transmitter 862 to the first touch unit 810.

With this structure, if a user controls the switch 863 while using the input device 800, the power transmitter 862 wirelessly transmits the power from the battery 861 to the power receiver 813 in accordance with disclosed methods. The power receiver 813 transmits the power received from the power transmitter 862 to the resonant circuit 812, and with this power, the resonant circuit 812 drives the resonant coil 811 to generate an electromagnetic field having a preset resonant frequency.

By foregoing the battery in the first touch unit 810 in this manner and having the centralized battery 861 to power all the touch units throughout the input device 800, it is possible to reduce the volume and weight of the first touch unit 810 and other touch units, and thereby increase an energy efficiency in terms of power distribution of the battery 861. If the battery is provided in each of the touch units as illustrated in a previous exemplary embodiment, it may be inconvenient to replace the batteries one by one in accordance with individual usage durations of the respective touch units. On the other hand, if the battery 861 is centralized such as in the present exemplary embodiment, the replacement of only one battery 861 is necessary regardless of individual usage time of the respective touch units because power is distributed and supplied from one battery 861 to the respective touch units.

There are various structures and methods for wirelessly supplying power from the main unit 860 to the first touch unit 810. For example, the method of wirelessly transmitting the power may be achieved by a radiative transmission method, a magnetic induction method, a magnetic resonance transmission method, an electromagnetic wave transmission method, etc. Among them, the present exemplary embodiment may employ the radiative transmission method of transmitting a relatively low output based on electromagnetic radiation within a distance of several meters, or the magnetic resonance transmission method based on evanescent wave coupling in which electromagnetic waves are moved from one medium to another medium through a near magnetic field when the two mediums are resonated at the same frequency.

Alternatively, the power may be supplied by a wired transmission method instead of the wireless transmission method.

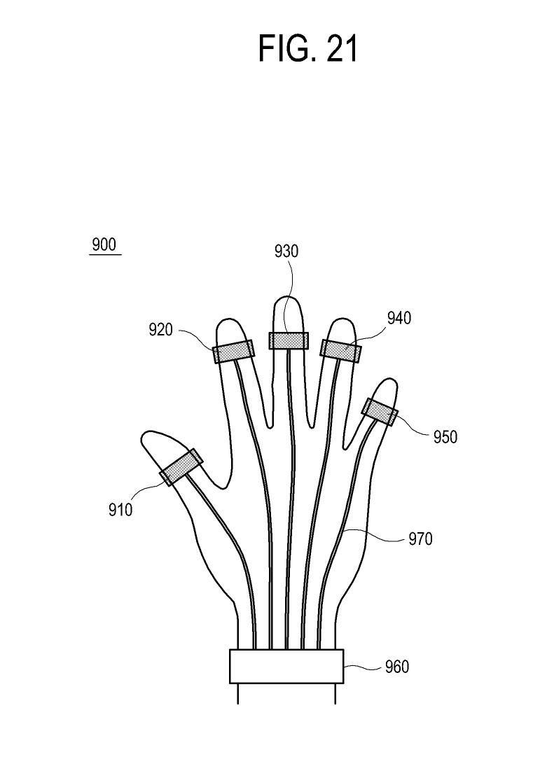

FIG. 21 illustrates an input device 900 according to a ninth exemplary embodiment.

As shown in FIG. 21, the input device 900 according to the ninth exemplary embodiment includes a plurality of touch units 910, 920, 930, 940, and 950 to be mounted to a user's respective fingers. The input device 900 may also include a main unit 960 for driving the plurality of touch units 910, 920, 930, 940, and 950, and cables 970 through which the power is supplied from the main unit 960 to the respective touch units 910, 920, 930, 940, and 950.

The plurality of touch units 910, 920, 930, 940, and 950 are each shaped like a ring and respectively placed on a user's fingers. The plurality of touch units 910, 920, 930, 940, and 950 generate preset electromagnetic fields, and the electromagnetic fields respectively generated by the touch units 910, 920, 930, 940, and 950 are different in resonant frequency from one another within one input device 900. Thus, the touch inputs caused by the touch units 910, 920, 930, 940, and 950 within the input device 900 are distinguishable from one another.

The main unit 960 controls individual operations of the respective touch units 910, 920, 930, 940, and 950, and supplies power for driving the touch units 910, 920, 930, 940, and 950. The main unit 960 is placed within a distance range from the plurality of touch units 910, 920, 930, 940, and 950 allowable by the length of the cable 970, when the input device 900 is used. For example, the main unit 960 is shaped like a bracelet and placed on a user's wrist. Unlike the eighth exemplary embodiment that wirelessly supplies the power, the present exemplary embodiment supplies power through the cable 970. Therefore, the limit to the distance of wireless transmission between the main unit 960 and each of the touch units 910, 920, 930, 940, and 950 according to the eighth exemplary embodiment is not relevant in the present exemplary embodiment.

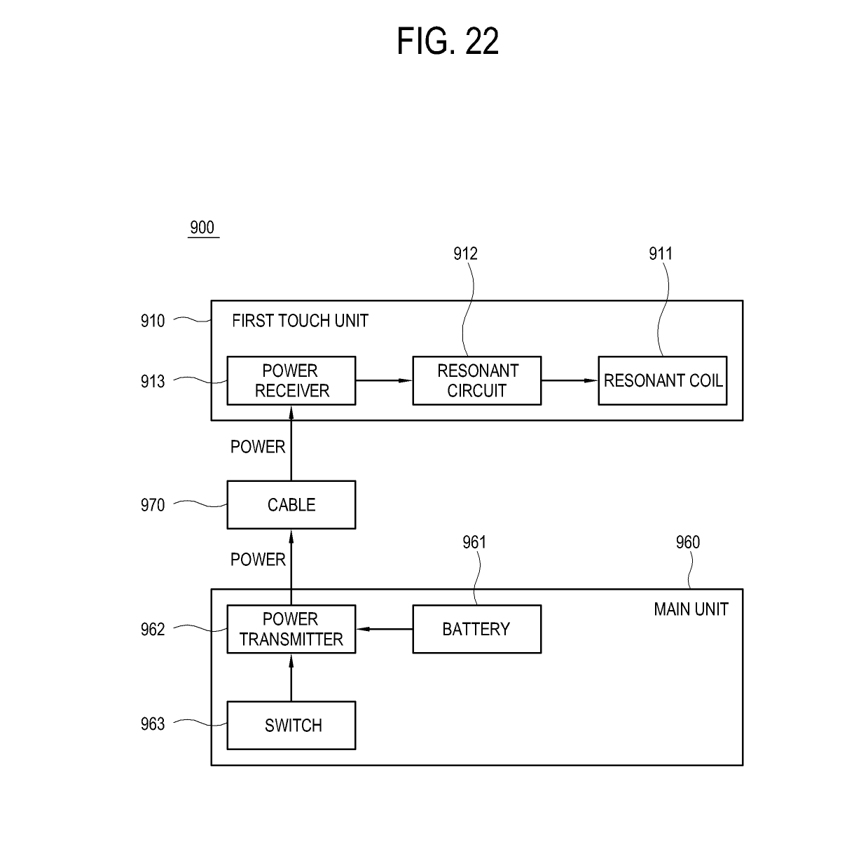

FIG. 22 is a block diagram of the input device 900 according to the ninth exemplary embodiment.

As shown in FIG. 22, the input device 900 includes the main unit 960, and the first touch unit 910 operating with power received from the main unit 960 through the cable 970. FIG. 20 shows only the first touch unit 910 among the plurality of touch units 910, 920, 930, 940, and 950 (see FIG. 19). The structures of the other touch units 920, 930, 940 and 950 (see FIG. 21) may be achieved by applying that of the first touch unit 910, and thus duplicative descriptions thereof will not be reproduced herein.

The first touch unit 910 includes a resonant coil 911 for generating an electromagnetic field, a resonant circuit 912 for driving the resonant coil 911 with the supplied power, and a power receiver 913 for receiving power from the main unit 960 through the cable 970 and supplying it to the resonant circuit 912. The resonant coil 911 and the resonant circuit 912 are substantially similar to those of the foregoing exemplary embodiments.

The main unit 960 includes a battery 961 for supplying the power, a power transmitter 962 for transmitting the power from the battery 961 to the first touch unit 910 through the cable 970, and a switch 963 for selecting whether to transmit the power from the power transmitter 962 to the first touch unit 910.

With this structure, if a user controls the switch 963 while using the input device 900, the power transmitter 962 transmits the power from the battery 961 to the power receiver 913 through the cable 970 in accordance with disclosed methods. The power receiver 913 transmits the power received from the power transmitter 962 to the resonant circuit 912, and the resonant circuit 912 drives the resonant coil 911 with the received power to generate an electromagnetic field having a preset resonant frequency.

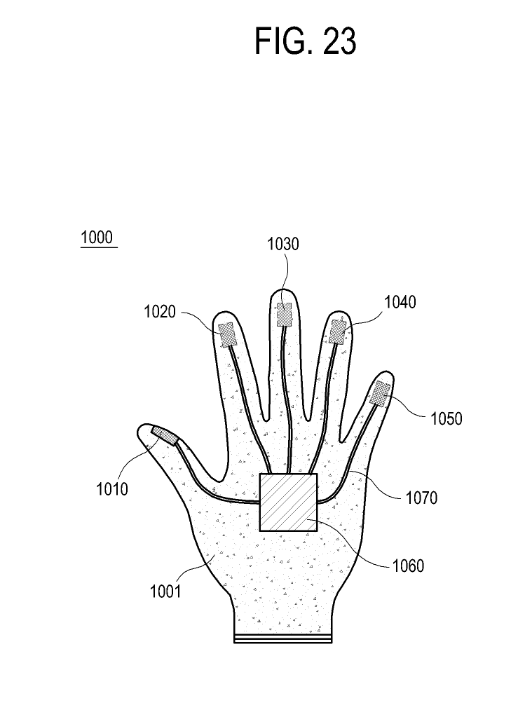

FIG. 23 illustrates an input device 1000 according to a tenth exemplary embodiment.

As shown in FIG. 23, the input device 1000 according to a tenth exemplary embodiment is shaped like a glove to be put on a user's hand. The input device 1000 includes a base 1001 having a glove shape, a plurality of resonant coils 1010, 1020, 1030, 1040, and 1050 disposed at touch positions of a user's five fingers on the base 1001, a circuit element 1060 for driving the respective resonant coils 1010, 1020, 1030, 1040, and 1050, and wires 1070 for electrically connecting each of the resonant coils 1010, 1020, 1030, 1040, and 1050 to the circuit element 1060.

The base 1001 is a glove made of one or more of various materials such as cloth, yarn, rubber, latex, etc., and prevents the input device 1000 from being separated from a user's hand while the user uses the input device 1000. Further, the base 1001 keeps the resonant coils 1010, 1020, 1030, 1040 and 1050 and the circuit element 1060 in place.

Each of the resonant coils 1010, 1020, 1030, 1040, and 1050 is placed at an area that may come in contact with the display when a user touches the display with her fingers (e.g., at fingers tips). The resonant coils 1010, 1020, 1030, 1040, and 1050 are driven by the circuit element 1060 to generate the electromagnetic fields having respective preset resonant frequencies. The resonant frequencies of the resonant coils 1010, 1020, 1030, 1040 and 1050 are different to be distinguishable from one another.

The circuit element 1060 is placed on a certain area of the base 1001. There are no limits to the placement of the circuit element 1060. Taking into account varying degrees of comfort when the user wears the input device 1000, the circuit element 1060 may be placed at an area corresponding to the back or wrist of the user's hand. The circuit element 1060 includes the battery and the resonant circuit to drive the respective resonant coils 1010, 1020, 1030, 1040, and 1050 through the wires 1070.

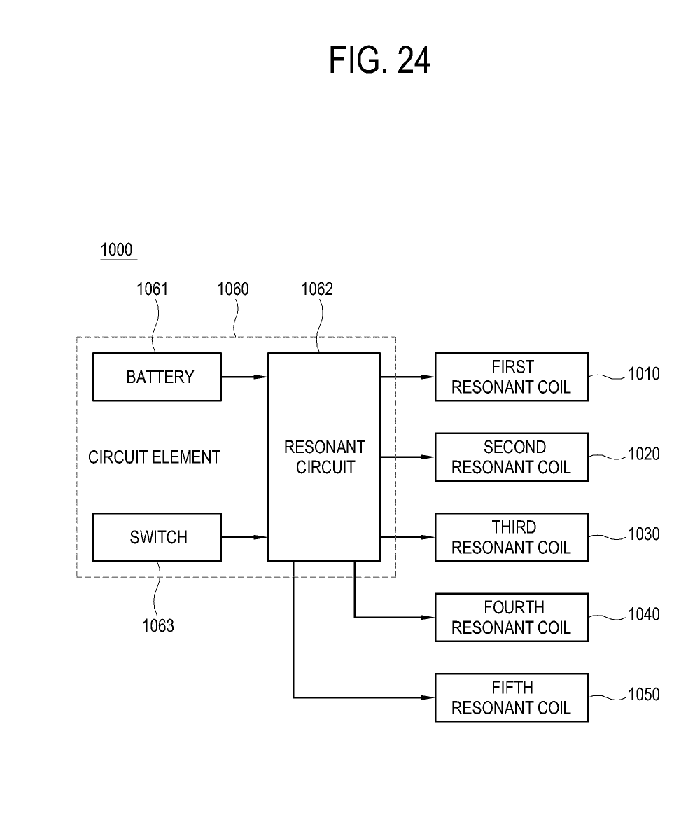

FIG. 24 is a block diagram of the input device 1000 according to the tenth exemplary embodiment.

As shown in FIG. 24, the circuit element 1060 of the input device 1000 includes a battery 1061 for supplying power, a resonant circuit 1062 for driving the resonant coils 1010, 1020, 1030, 1040, and 1050 with the power supplied from the battery 1061, and a switch 1063 for turning on/off the resonant circuit 1062.

With this structure, the resonant circuit 1062 is activated when a user turns on the switch 1063. The resonant circuit 1062 individually drives the resonant coils 1010, 1020, 1030, 1040, and 1050 with the power supplied from the battery 1061. At this time, the resonant circuit 1062 respectively drives the resonant coils 1010, 1020, 1030, 1040, and 1050 by different resonant frequencies, so that the electromagnetic fields generated by the resonant coils 1010, 1020, 1030, 1040, and 1050 can be distinguished from one another.

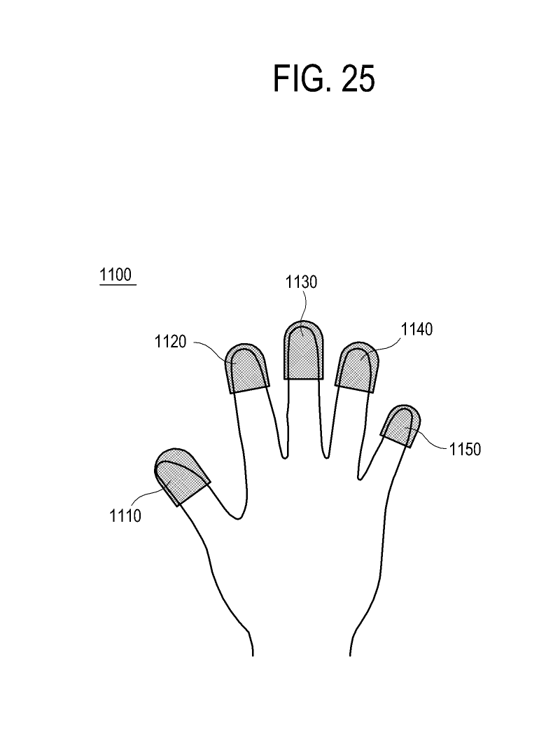

FIG. 25 illustrates an input device 1100 according to an eleventh exemplary embodiment.

As shown in FIG. 25, the input device 1100 according to the eleventh exemplary embodiment includes a plurality of touch units 1110, 1120, 1130, 1140, and 1150 respectively mounted to a user's fingers. In this exemplary embodiment, five touch units 1110, 1120, 1130, 1140, and 1150 are provided corresponding to the user's five fingers. However, the touch units 1110, 1120, 1130, 1140, and 1150 do not have to correspond to all of the fingers. Alternatively, two, three or four touch units may be provided. Five or more touch units may also be provided if the user is to use two hands. In other words, there are no limits to the number of touch units 1110, 1120, 1130, 1140, and 1150.

The touch units 1110, 1120, 1130, 1140, and 1150 are each shaped like a thimble or a finger protector to surround and cover each tip of the fingers, and worn on the user's fingers. The touch units 1110, 1120, 1130, 1140, and 1150 include a first touch unit 1110 to be mounted on the user's thumb, a second touch unit 1120 to be mounted on the index finger, a third touch unit 1130 to be mounted on the middle finger, a fourth touch unit 1140 to be mounted on the ring finger, and a fifth touch unit 1150 to be mounted on the little finger.

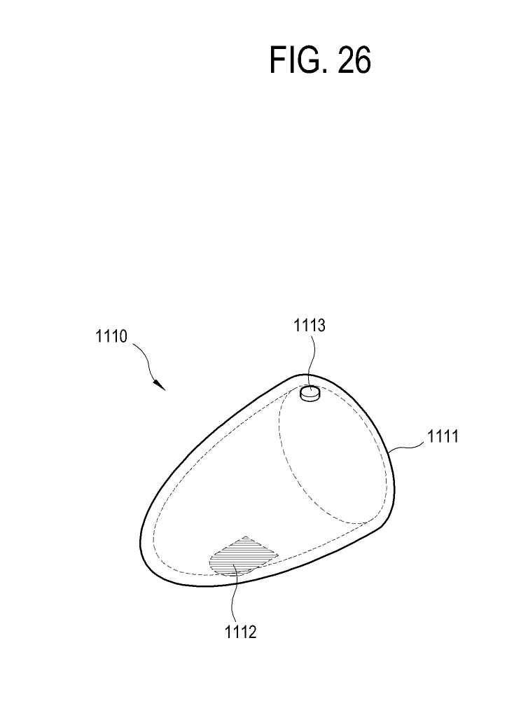

FIG. 26 is a perspective view of the first touch unit in the input device shown in FIG. 25.

As shown in FIG. 26, the first touch unit 1110 includes a housing 1111 shaped like a thimble so as to fit a fingertip. The housing 1111 forms an accommodating space for accommodating a user's fingertip, and has a space for receiving circuit elements of the first touch unit 1110.

The first touch unit 1110 is provided with a resonant coil 1112 in an area on the outer surface of the housing 1111, which makes a touch while being put on a user's finger. Further, a switch 1113 to be toggled by a user is provided on the outer surface of the housing 1111. The switch 1113 is provided to turn on and off the circuit element of the first touch unit 1110, and may be achieved variously by a mechanical switch, an electronic switch, etc. That is, a user may control the switch 1113 to activate or deactivate the internal circuit of the first touch unit 1110. Thus, a user turns off the first touch unit 1110 by the switch 113 if the first touch unit 1110 is not in use, thereby preventing a battery of the first touch unit 1110 from being wastefully discharged.

In this exemplary embodiment, the touch unit 1110 operates by a substantially similar principle as that described with regard to the fifth exemplary embodiment (see FIG. 9), and therefore detailed descriptions thereof will be omitted.

Below, a method of receiving touch input information from a touch sensor in the display apparatus while an application using the touch input information is running will be described.

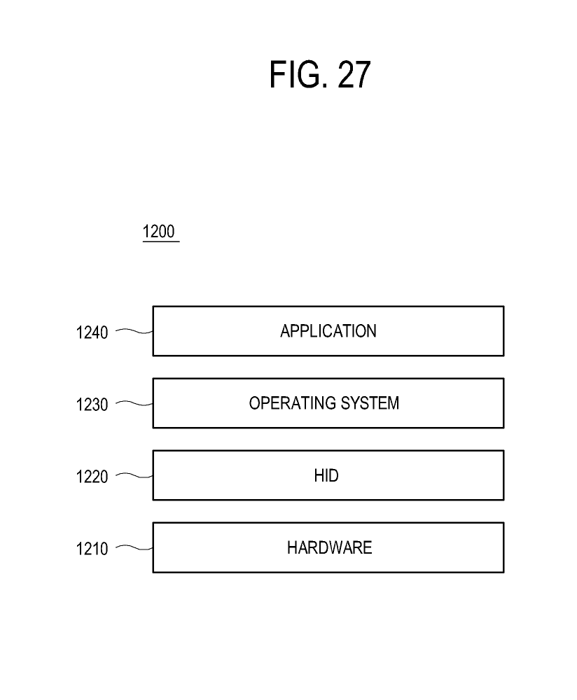

FIG. 27 is a block diagram showing a hierarchical structure of platforms for the display apparatus according to a twelfth embodiment.

As shown in FIG. 27, platforms 1200 of the display apparatus according to the eleventh embodiment include hardware 1210 in the lowest layer, a human interface device (HID) 1220, an operating system 1230 for controlling the hardware 1210, and an application 1240 executed on the operating application 1230.

The hardware 1210 refers to various elements of the display apparatus described in the foregoing exemplary embodiments (e.g., the touch sensor).

The HID 1220 refers to standards of an interface used by a user to control operations of a device. As an example of devices in the HID class include a keyboard, a pointing device such as a standard mouse, a track ball mouse, a joystick or the like, a front panel control such as a knob, a switch, a button, a slider, a touchscreen, etc. In this exemplary embodiment, the HID 1220 indicates communication standards between an operating system 1230 and the touch sensor so that the operating system 1230 can control the touch sensor.

The operating system 1230 refers to system software that manages the hardware 1210 of the display apparatus and provides a hardware abstraction platform and a common system service in order to execute the general application 1240. The operating system 1230 provides system resources such as the CPU or the like to be used by the executed application 1240, and abstracts them to offer a service such as a file system and the like. The operating system 1230 provides a user with environments for easily and efficiently executing applications. Further, the operating system 1230 efficiently assigns, administers, and protects the hardware 1210 and software resources of the display apparatus, monitors improper use of the resources, and manages the operation and control of the resources of input/output devices and the like.

The application 1240 or the application software broadly means any software executed on the operating system 1230, and specifically means software directly handled by a user on the operating application 1230. In the latter case, the application 1240 may be a complementary set of the system software such as a boot-loader, a driver, the operating system. In this exemplary embodiment, the application 1240 executes a corresponding operation based on the touch input information transmitted from the operating system 1230.

Below, the process of the touch input information being transmitted from the hardware to the operating system will be described.

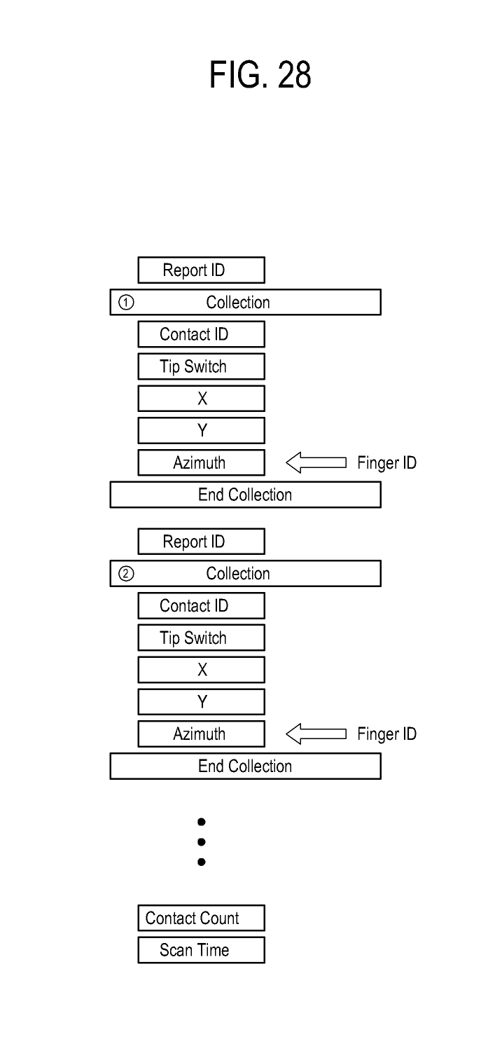

FIG. 28 illustrates a data structure used for storing touch input information according to the twelfth exemplary embodiment.

As shown in FIG. 28, the touch input information transmitted from the touch sensor to the operating system has a data structure that complies with the HID standards supported by the operating system. The touch sensor acquires information about coordinates of a position where a touch input of the input device occurs, and information about the ID corresponding to the touch input. The touch sensor converts the acquired information into the touch input information in accordance with the HID standards, and transmits the converted information to the operating system.

In the touch input information, a collection refers to a group of data corresponding to a single touch input received at one time. The touch sensor records 2D coordinates of the position, where the touch input occurs, in data fields that are labeled X and Y within the collection.

The touch sensor selects either an empty collection where information about touch input is not yet recorded or a temporary data structure which is not in use, among the available collections. The touch sensor records finger ID (i.e., ID information of the touch input in the selected code region) within the selected collection. Other metadata may be also stored in the fields within the collection data structure. Here, the finger ID may, for example, be stored in field labeled ‘Azimuth,’ but not limited thereto. Alternatively, other data fields may be used if the foregoing conditions are satisfied.

If the operating system is Linux or Microsoft's Windows 8, which supports multi-touch HID, essential information and optional information, which is selectively used in accordance with circumstances, may be recorded. That is, the touch sensor selects the data field corresponding to the selected usage, and records the ID information of the touch input in the selected data field.

Optional information may include such metadata as pressure, barrel, X tilt, Y tilt, twist, etc. as well as azimuth. These comply with the HID standards. Since the ID information is transmitted in accordance with the HID standards, the present embodiments are applicable without violating the HID standards, and there is no need of developing or installing a separate driver.

However, if the operating system is Microsoft's Windows 7, the operating system does not support the usage of azimuth. In this case, the touch sensor may use WM INPUT to send ID information to the operating system. WM INPUT is a standard OS command for sending a message in this operating system.

In addition, the HID standards may be modified to transmit the ID information.

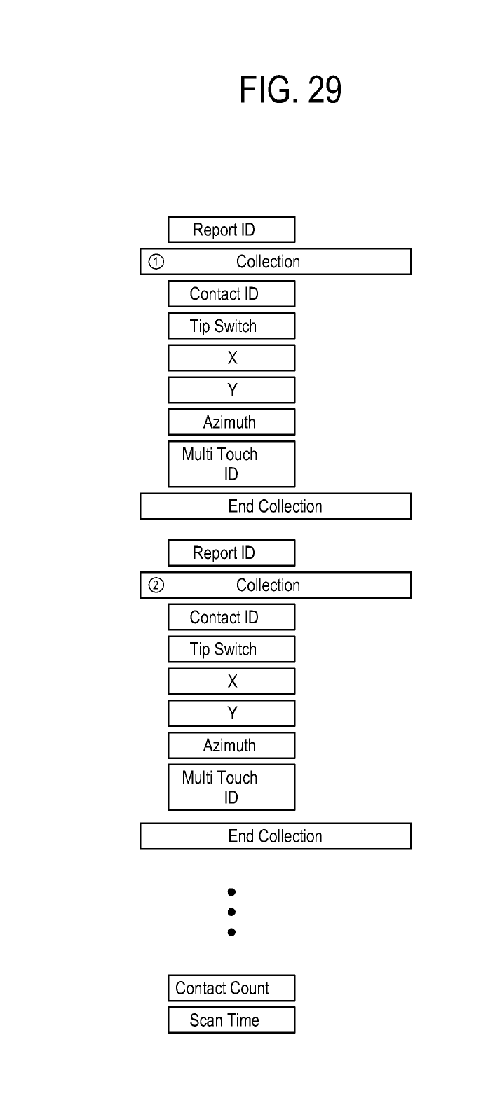

FIG. 29 illustrates a data structure used for storing touch input information according to a thirteenth exemplary embodiment.

As shown in FIG. 29, the data structure of the basic touch input information complies with the HID standards. However, the touch sensor may add a data field called ‘Multi Touch ID’ within a collection, and record the ID information in this field.

In the foregoing twelfth exemplary embodiment, the HID standards are used without modification, and thus the ID information (i.e., non-standard data element) is recorded in a temporary data field that is not in use. On the contrary, the present exemplary embodiment modifies the HID standards to add an extra data field for recording the ID information.

As disclosed in the foregoing exemplary embodiments, the operating system receives the touch input information and transmits the position coordinates and ID information of the touch input information to the application. The application executes a previously designated operation or function based on the position coordinates and ID information received from the operating system.

The foregoing exemplary embodiment describes the structure of the input device employing a resonant system. However, the structure of the input device is not limited to the foregoing exemplary embodiments, and the present disclosure is not limited to the input device employing the resonant system. Below, an input device employing systems other than the resonant system will be described.

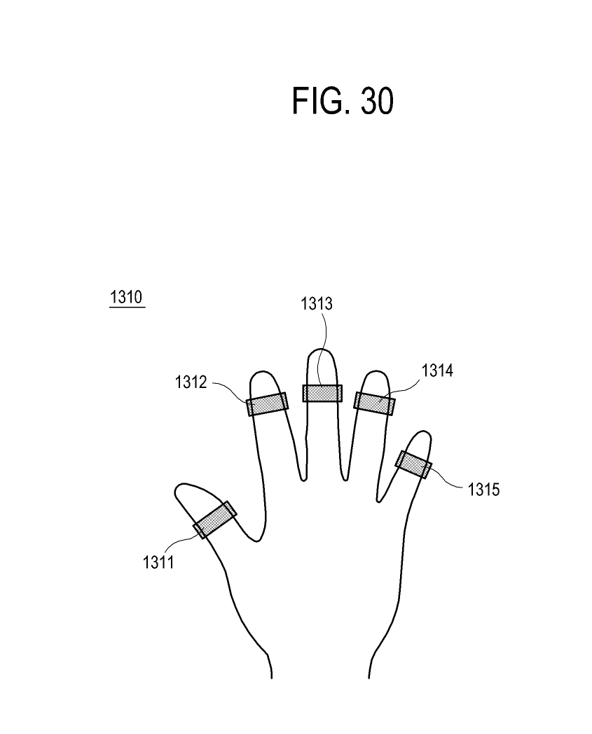

FIG. 30 illustrates an input device 1310 according to the thirteenth exemplary embodiment.

As shown in FIG. 30, the input device 1310 according to the thirteenth exemplary embodiment includes a plurality of touch units 1311, 1312, 1313, 1314, and 1315 to be respectively mounted to a user's fingers. The touch units 1311, 1312, 1313, 1314, and 1315 are each shaped like a ring and respectively placed on the user's five fingers, thereby having a similar shape as those of the foregoing exemplary embodiments.

Each of the touch units 1311, 1312, 1313, 1314, and 1315 is internally provided with a capacitor (or condenser). The capacitor or condenser is an electrical component having capacitance and is one of the basic elements of electronic circuitry. The capacitor stores electric potential energy, and has a structure where an insulator is interposed between two conductive plates. Here, the capacitors of the respective touch units 1311, 1312, 1313, 1314, and 1315 are different in capacitance, so that the touch inputs caused by the respective touch units 1311, 1312, 1313, 1314, and 1315 can be distinguished from one another. In this regard, details will be described later.

Below, the touch sensor for sensing the touch input of the input device 1310 will be described. The touch sensor is provided in the main body of the display apparatus, and has substantially similar structures as described above.

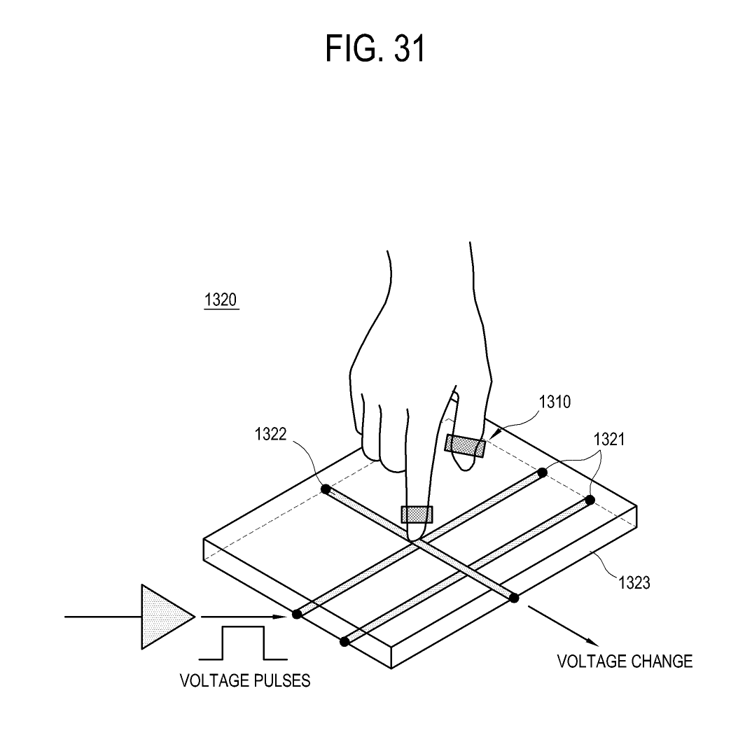

FIG. 31 is a partial perspective view of a structure of a touch sensor 1320 according to the thirteenth exemplary embodiment.

As shown in FIG. 31, the touch sensor 1320 includes transmitting wires 1321 and receiving wires 1322, which are layered on the display panel. The transmitting wires 1321 are arranged along a horizontal direction or a vertical direction of the display panel, and the receiving wires 1322 are arranged along the direction perpendicular to the transmitting wires 1321.

Further, an insulating layer 1323 is formed in between the transmitting wires 1321 and the receiving wires 1322. Further, the touch sensor 1320 may further include a glass cover layered on the topmost layer to be touched by a user and providing protection. FIG. 31 illustrates that the receiving wires 1322 is placed above the transmitting wires 1321, but the touch sensor 1320 is not limited thereto. Alternatively, the transmitting wires 1321 may be placed above the receiving wires 1322. However, it is preferable that the receiving wires 1322 is placed above the transmitting wires 1321 in order to improve touch sensitivity.

The transmitting wires 1321 are achieved by arranging wires extending in a preset first direction at preset intervals. To sense a position touched by a user, voltage pulses are applied to each of the transmitting wires 1321.

The receiving wires 1322 are achieved by arranging wires extending in a preset second direction at preset intervals. The first direction and the second direction are different from each other, and may, for example, be perpendicular to each other. From a top view of the touch sensor 1320, the transmitting wires 1321 and the receiving wires 1322 intersect with each other to form a lattice.

When voltage pulses having a preset level are applied to each transmitting wire 1321, an electromagnetic field is generated in between the transmitting wire 1321 and the receiving wire 1322, thereby creating voltage coupling having a preset level in the receiving wire 1322. In this state, if a user who is wearing the input device 1310 touches the receiving wire 1322 with a fingertip, some electric charges are absorbed in the user's finger and the input device 1310, and therefore total energy output from the receiving wire 1322 is decreased. Such a change in energy level causes the voltage of the receiving wire 1322 to be varied, and it is thus possible to sense the touch position based on the variation in voltage.

Here, the electric charges are absorbed in the touch unit mounted to a user's finger between the finger and the touch unit of the input device 1310. If the amounts of electric charges respectively absorbed by touch units on the user's fingers are substantially the same, the capacitor of each touch unit creates a difference in the amount of absorbed electric charges among the fingers at the touch input. The capacitors of the respective touch units are different from each other in capacitance, and thus different in the amount of absorbing the electric charges. Accordingly, the touch sensor can distinguish between the touch units based on the level of the sensed voltage.

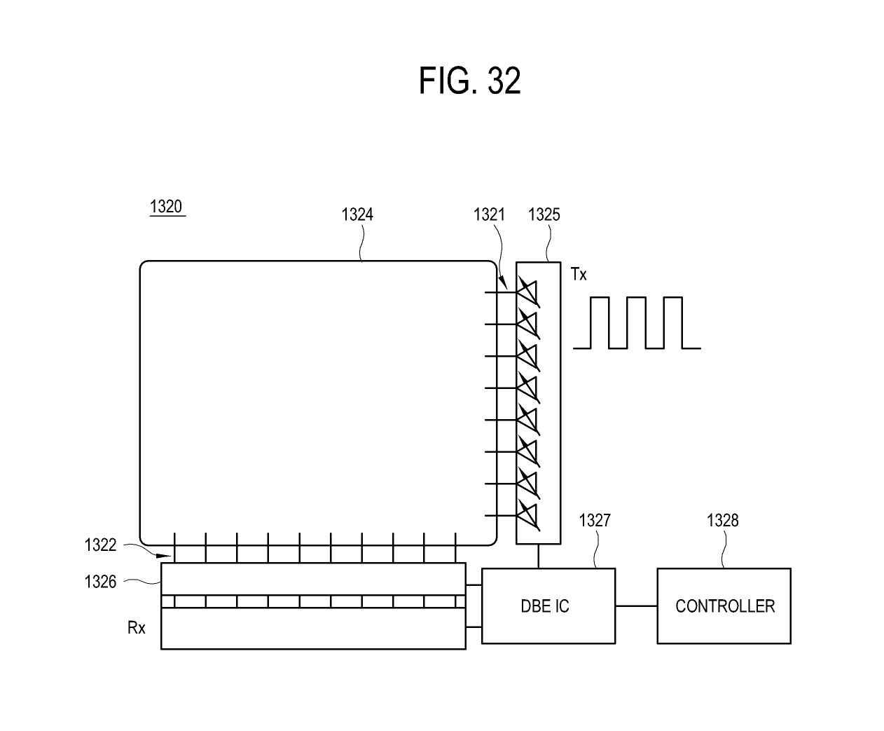

FIG. 32 illustrates a control structure for the touch sensor 1320 according to the thirteenth exemplary embodiment.

As shown in FIG. 32, the touch sensor 1320 includes a transmitting circuit element 1325 for applying voltage pulses to the plurality of transmitting wires 1321 formed in a touch area 1324, a receiving circuit element 1326 for receiving a voltage from the plurality of receiving wires 1322 formed in the touch area 1324. The touch sensor 1320 may also include a digital back-end integrated circuit (DBE IC) 1327 for controlling the voltage pulses to be applied to the transmitting circuit element 1325, determining the touch position by analyzing the voltage received in the receiving circuit element 1326, and specifying a touching object. Further, the touch sensor 1320 may further include a controller 1328 for executing an operation corresponding to the determined touch input information.

When the voltage pulses are applied to the transmitting circuit element 1325, the electromagnetic field is formed in between the transmitting wire 1321 and the receiving wire 1322, and thus a voltage having a preset level is output from the receiving wire 132. While no touch inputs are occurring on the touch area 1324, there are no changes in the output voltage in all the receiving wires 1322.

If the touch input occurs at a certain position on the touch area 1324, the voltage output from the receiving wire 1322 corresponding to the certain position drops while the voltages output from the other receiving wires 1322 remain unchanged. Thus, it is possible to identify the touch position on the touch area 1324.

Further, the touch unit generating the touch input is identified in accordance with by how much the voltage output from the receiving wire 1322 is dropped.

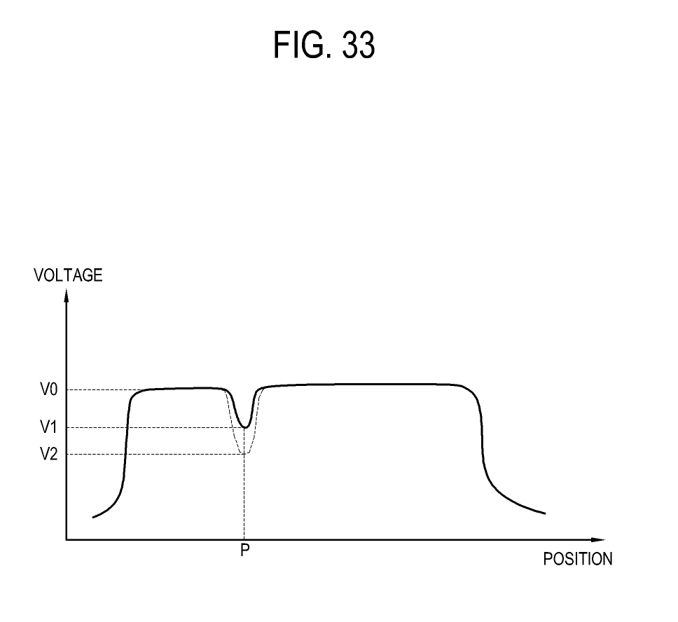

FIG. 33 is a graph showing a voltage level output from a receiving wire of the touch sensor according to the thirteenth exemplary embodiment.

As shown in FIG. 33, the output voltages corresponding to the positions of the receiving wires generally have a uniform level of V0 except at the position where the touch input occurs. Thus, the respective receiving wires output the voltage having the uniform level of V0 while there are no touch inputs, because the electromagnetic field is formed between the transmitting wire and the receiving wire as described above. In this graph, the horizontal axis indicates the position of the receiving wire, and the vertical axis indicates the voltage.

If a user who is wearing the first touch unit makes the touch input at a certain position P, the first touch unit absorbs some electric charges from the electromagnetic field. Thus, the voltage output from the receiving wire corresponding to position P is dropped from V0 to V1, while the voltages output from the other receiving wires remain at V0.

In addition, if a user who is wearing the second touch unit makes a touch input at the same position P, the second touch unit absorbs some electric charges from the electromagnetic field. Here, the capacitor of the second touch unit is different in capacitance from the capacitor of the first touch unit. For example, if the capacitor of the second touch unit has higher capacitance than the capacitor of the first touch unit, then the amount of electric charges absorbed by the second touch unit is greater than the electric charges absorbed by the first touch unit. Therefore, the voltage output from the receiving wire corresponding to position P is dropped from V0 to V2, where V2 is lower than V1.

With this principle, the touch sensor distinguishes among the touch units of the input device based on the dropped levels of the voltages output from the receiving wires.

Below, a method of sensing the touch input by the display apparatus in this exemplary embodiment will be described.

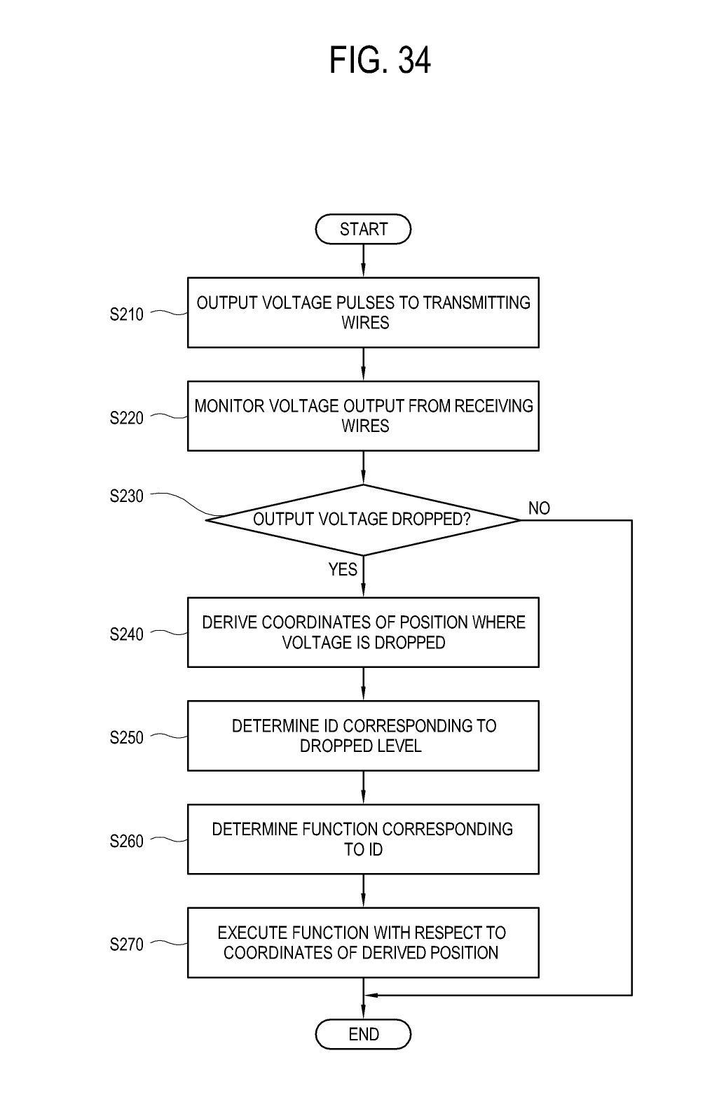

FIG. 34 is a flowchart for controlling a display apparatus according to the thirteenth exemplary embodiment.

As shown in FIG. 34, at operation S210, the display apparatus outputs voltage pulses to the transmitting wires.

At operation S220, the display apparatus monitors the levels of the voltages output from the receiving wires based on the electromagnetic field formed in between the transmitting wire and the receiving wire.

At operation S230, the display apparatus determines whether a voltage output from a certain receiving wire is dropped or not.

If it is determined that the voltage output from the certain receiving wire is dropped, at operation S240, the display apparatus derives (i.e., determines) coordinates of the position where the voltage is dropped.

At operation S250, the display apparatus determines the ID corresponding to the dropped voltage level. Here, the determination of the ID may be achieved by searching the previously stored database. For example, the database may store a mapping of the ID to a numerical value of the dropped level of the output voltage. When the value of the dropped level is derived, the display apparatus searches the database for this value, and thus determines the ID.

At operation S260, the display apparatus determines a function corresponding to the ID.

At operation S270, the display apparatus executes the function with respect to the derived coordinates of the position.

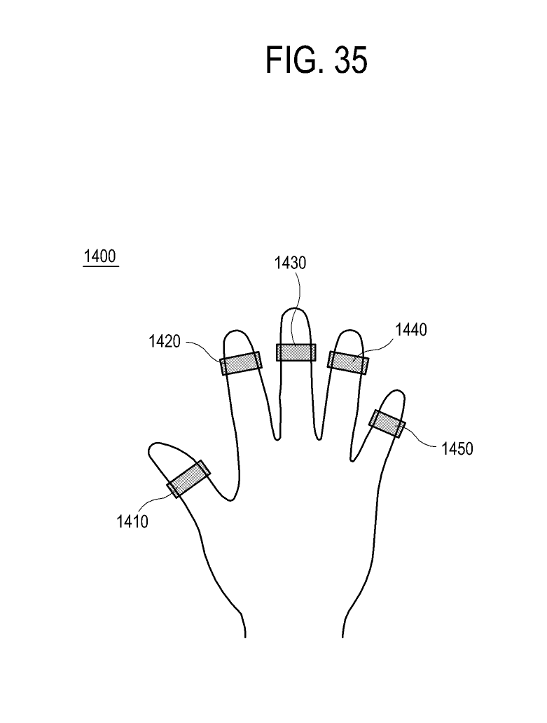

FIG. 35 illustrates an input device 1400 according to a fourteenth exemplary embodiment.

As shown in FIG. 35, the input device 1400 according to the fourteenth exemplary embodiment includes a plurality of touch units 1410, 1420, 1430, 1440, and 1450 to be respectively mounted to a user's five fingers. In this exemplary embodiment, five touch units 1410, 1420, 1430, 1440, and 1450 are provided corresponding to the user's five fingers. However, the touch units 1410, 1420, 1430, 1440, and 1450 do not have to correspond to all the fingers, and there may be provided two, three, or four touch units. In other words, there are no limits to the number of touch units 1410, 1420, 1430, 1440, and 1450.

The touch units 1410, 1420, 1430, 1440, and 1450 are each shaped like a ring to be worn on a user's fingers. The touch units 1410, 1420, 1430, 1440, and 1450 include a first touch unit 1410 to be mounted to a user's thumb, a second touch unit 1420 to be mounted to the index finger, a third touch unit 1430 to be mounted to the middle finger, a fourth touch unit 1440 to be mounted to the ring finger, and a fifth touch touching unit 1450 to be mounted to the little finger.

Below, each structure of the touch units 1410, 1420, 1430, 1440, and 1450 will be described in detail. The touch units 1410, 1420, 1430, 1440, and 1450 are basically similar to one another, and therefore the structure of only the first touch unit 1410 will be described as an illustration. Regarding the other touch units 1420, 1430, 1440, and 1450, only the difference from the first touch unit 1410 will be described.

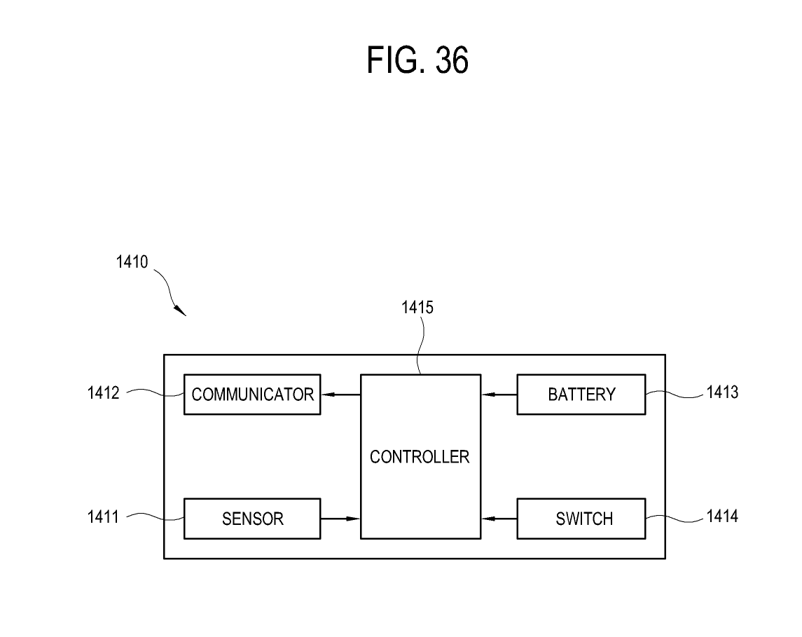

FIG. 36 is a block diagram of the first touch unit 1410 according to the fourteenth exemplary embodiment.

As shown in FIG. 36, the first touch unit 1410 includes a sensor 1411 for sensing a currently touched position, a communicator 1412 for communicating with the exterior, a battery 1413 for supplying power, and a controller 1415 for determining the position coordinates in accordance with sense results of the sensor 1411 and transmitting the determined position coordinates to a host through the communicator 1412.

In the display apparatus according to the foregoing exemplary embodiments including the input device and the main device, the main device senses the touch position of the touch unit and derives the coordinates of the touch position. However, in this exemplary embodiment, the input device derives the coordinates of the touch position and transmits the derived coordinates to the host (i.e. the main device).

The sensor 1411 senses the touch position on the display panel when the first touch unit 1410 touches the display panel of the main device, and transmits the sense result to the controller 1415. The structure and method for sensing the touch position by the sensor 1411 may be variously designed.

For instance, the sensor 1411 may emit an infrared ray and receive the infrared ray reflected off a marking placed on the display panel, thereby sending information about the shape of the marking to the controller 1415. The display panel has special markings previously formed on the surface to indicate the coordinates of each position throughout the entire display surface, and the sensor 1411 receives the infrared ray reflected from the touch position to thereby sense the shape of the marking at the corresponding positions. The marking may be, for example, an optical pattern of dots, bars, geometric shapes, etc. that conveys information.

The controller 1415 calculates the coordinates of the touch position based on the shape of the marking received from the sensor 1411. Alternatively, the controller 1415 may directly transfer data about the shape of the marking to the host instead of calculating the coordinates. In this case, the calculation of coordinates is performed by the host.

The communicator 1412 wirelessly transmits the information about the position coordinates received from the controller 1415 to the host. To this end, the communicator 1412 may be achieved by a wireless communication module, for example a Bluetooth module.

Bluetooth is a direct communication method between devices using IEEE 802.15.1 standards. Bluetooth employs a frequency band of 2400-2483.5 MHz belonging in the industrial, scientific, and medical (ISM) radio bands. To prevent interference with other systems employing frequencies higher or lower than this frequency band, 79 channels corresponding to a frequency band of 2402-2480 MHz, which excludes a band higher than 2400 MHZ by 2 MHz and a band lower than 2483.5 MHz by 3.5 MHz.

Because the frequency band is shared with many systems, electromagnetic interference may occur between the systems. To prevent this, Bluetooth uses a frequency hopping method. Frequency hopping refers to a technique where a packet (i.e. data) is transmitted little by little while rapidly moving along many channels in accordance with a certain pattern. Bluetooth hops between the allocated 79 channels 1600 times per second. This hopping pattern has to be synchronized between the devices in order to establish reliable communication. When the devices are connected by Bluetooth, they are respectively designated as a master and a slave. If the slave device is not synchronized with the frequency hopping of the master device, the communication between the two devices is not allowed. With this, it is possible to avoid electromagnetic interference with other systems and thus make stable communication. For reference, the maximum number of slave devices connectable to one master device is seven. Further, only the communication between the master device and the slave device is possible and the communication between the slave devices is impossible. However, the roles of the master and the slave are not fixed but variable depending on circumstances.

The communicator 1412 has its own hardware ID. The communication modules including Bluetooth and other various protocols are assigned their own hardware ID numbers. For example, the communication module employs media access control (MAC) address in case of Wi-Fi or Ethernet, universally unique identifier (UUID) in case of Universal Plug and Play (UPNP), Pear-To-Peer (P2P) Device Address in case of Wi-Fi direct, and Bluetooth MAC address in case of Bluetooth. Thus, the communicator 1412 transmits the touch input information about the position coordinates and its own ID to the host.

Here, the ID of the communicator 1412 of the first touch unit 1410 is different from the IDs of the communicators of the other touch units 1420, 1430, 1440, and 1450 of the input device 1400 (see FIG. 35). Therefore, the host determines that the touch input information is received from the first touch unit 1410 based on the ID of the communicator 1412 extracted from the touch input information wirelessly received from the first touch unit 1410.

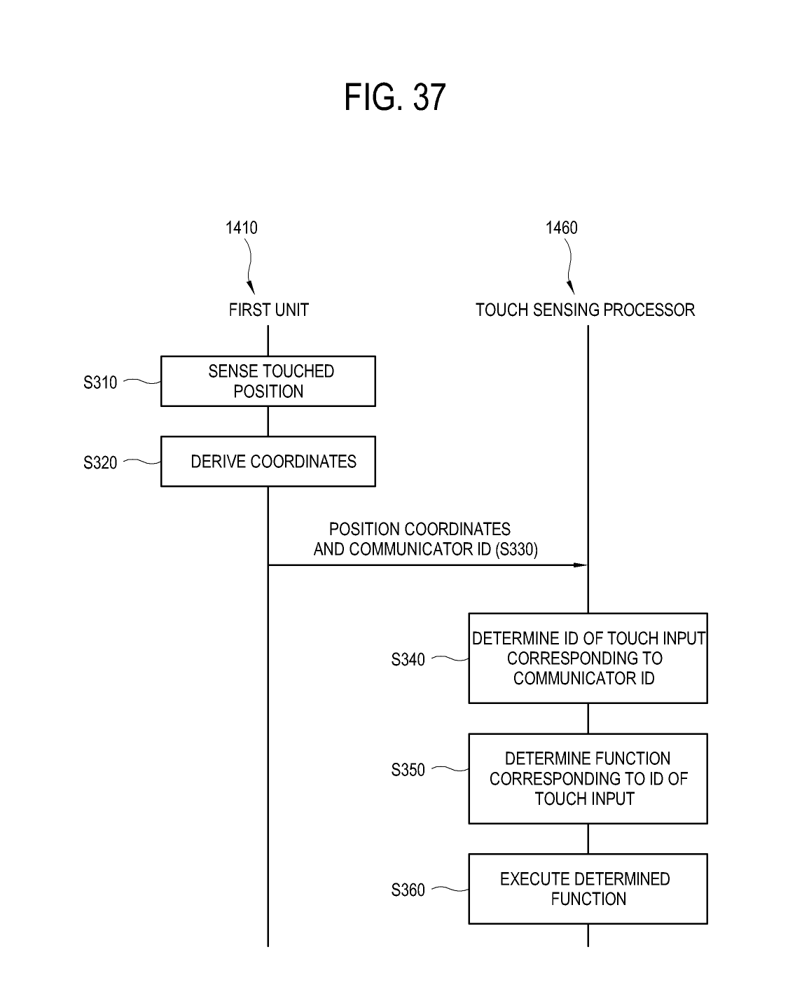

FIG. 37 is a sequence diagram for operations between the first touch unit 1410 of the input device and the touch sensing processor 1460 of the main device according to the fourteenth exemplary embodiment.

As shown in FIG. 37, at operation S310, the first touch unit 1410 senses the touch position. At operation S320, the first touch unit 1410 derives (i.e., determines) the coordinates of the sensed touch position.

At operation S330, the first touch unit 1410 transmits the position coordinates and the communicator ID to the touch sensing processor 1460.

At operation S340, the touch sensing processor 1460 determines the ID of the touch input based on the communicator ID. The ID of the touch input is determined by searching the database where the communicator ID is mapped to the ID of the touch input.

At operation S350, the touch sensing processor 1460 determines a function corresponding to the ID of the touch input. At operation S360, the touch sensing processor 1460 executes the determined function with respect to the corresponding touch input.

Below, placement of a marking corresponding to each position on the display panel so that the first touch unit 1410 can sense the touch position on the display panel will be described.

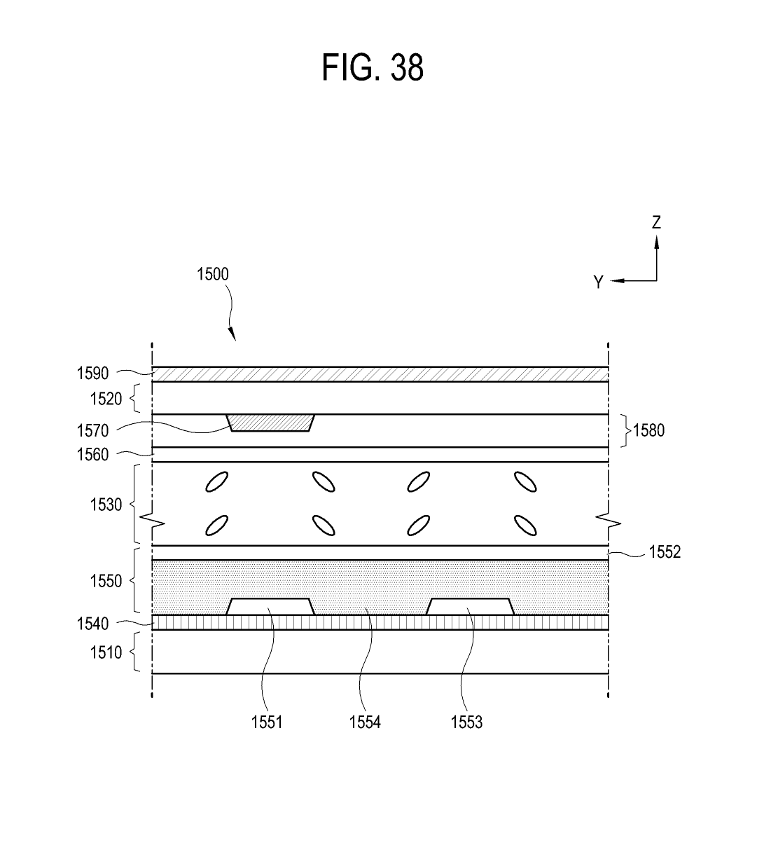

FIG. 38 is a lateral cross-section view of a display panel 1500 according to a fifteenth exemplary embodiment. This display panel 1500 is applied to the main device of the display apparatus.

As shown in FIG. 38, the display panel 1500 includes a lower substrate 1510 and an upper substrate 1520 that face each other, a liquid crystal layer 1530 interposed in between the lower substrate 1510 and the upper substrate 1520, a color filter layer 1540, and a pixel layer 1550. Such a structure of the display panel 1500 described with regard to this embodiment does not disclose all the elements, and may include additional elements or be modified in accordance with other methods. Some of the elements illustrated in FIG. 38 may be omitted.

The lower substrate 1510 and the upper substrate 1520 are transparent substrates arranged to face each other, leaving a space in a traveling direction of light emitted from the backlight unit (i.e., a Z direction shown in FIG. 38). The lower substrate 1510 and the upper substrate 1520 may be achieved by glass or plastic substrates. In case where a plastic substrate is used, the substrates can be implemented with polycarbonate, polyimide (PI), polyethersulfone (PES), polyacrylate (PAR), polyethylenenaphthalate (PEN), polyethylene terephthalate (PET), etc.

The lower substrate 1510 and the upper substrate 1520 may be required to have various properties depending on the driving method of the liquid crystal layer 1530. For example, if the liquid crystal layer 1530 is driven by a passive matrix method, the lower substrate 1510 and the upper substrate 1520 may be made of soda lime glass. On the other hand, if the liquid crystal layer 1530 is driven by an active matrix method, the lower substrate 1510 and the upper substrate 1520 may be made of alkali-free glass and borosilicate glass.

The liquid crystal layer 1530 is sandwiched in between the lower substrate 1510 and the upper substrate 1520, and adjusts light transmission as the array of liquid crystal is altered in accordance with a driving signal. Unlike an ordinary liquid that lacks regularity in molecular orientation and array, liquid crystal retains some regularity while still being in a liquid phase. For example, some solid material may exhibit double refraction or like anisotropic properties when the solid is heated and melted. The liquid crystal likewise exhibits optical properties such as double refraction or color change. In other words, this material is called the liquid crystal because the material exhibits properties of both a liquid and a crystal (i.e., regularity of a crystal and a liquid phase of a liquid). The liquid crystal may alter its optical properties by rearranging its molecular orientation depending on the applied voltage.

The liquid crystal of the liquid crystal layer 1530 may be classified into one of several phases nematic, cholesteric, smectic, and ferroelectric phases in accordance with the molecular arrangement of the liquid crystal. Further, the array of the liquid crystal layer 1530 may be adjusted by various operation modes of the display panel 1500, such as a twisted nematic (TN) mode, a vertical alignment (VA) mode, a patterned vertical alignment (PVA) mode, an in-plain switching (IPS) mode, etc. To achieve a wide view angle, for example, subpixels may be divided or patterned, and refractivity of the liquid crystal may be uniformly adjusted.

The color filter layer 1540 imbues one or more of the red, green, and blue (RGB) colors to incident light of the display panel 1500 and transfers colors to the liquid crystal layer 1530. In the display panel 1500, a single pixel may consist of subpixels respectively corresponding to RGB colors, and thus the color filter layer 1540 performs filtering corresponding to colors with respect to the respective subpixels. The color filter layer 1540 may be achieved by a dye layer colored with a dye of corresponding color. As the light passes through the color filter layer 1540, the subpixels emit light with different colors.

As shown in FIG. 38, the color filter layer 1540 may be interposed between the lower substrate 1510 and the pixel layer 1550, and may be arranged at a side of the upper substrate 1520 in accordance with disclosed methods. In other words, there are no limits to the arrangement of the color filter layer 1540.

The pixel layer 1550 includes a plurality of pixels by which the liquid crystal array of the liquid crystal layer 1530 is changed in response to a control and/or driving signal. Each pixel includes a plurality of subpixels corresponding to RGB colors. Each subpixel includes a thin film transistor (TFT) 1551 as a switching device, a pixel electrode 1552 electrically connected to the TFT 1551, a sustaining electrode 1553 for accumulating electric charges, and a protection layer 1554 for covering the TFT 1551 and the sustaining electrode 1553.

The TFT 1551 has a structure consisting of an insulating layer and a semiconductor layer that are layered on a gate electrode, and a resistance contact layer, a source electrode, and a drain electrode are layered thereon. The resistance contact layer is made of silicide or n+ hydrogenated amorphous silicon or the like material highly doped with n-type impurities. The source electrode is electrically connected to the pixel electrode 1552.

The pixel electrode 1552 is made of a transparent conductive material such as indium tin oxide (ITO), indium zinc oxide (IZO), etc.

In addition, the display panel 1500 further includes a common electrode 1560, a black matrix 1570 and an over-coating layer 1580, which are interposed between the upper substrate 1520 and the liquid crystal layer 1530.

The common electrode 1560 is layered on the liquid crystal layer 1530. The common electrode 1560 is made of a transparent conductive material such as ITO, IZO, etc., and together with the pixel electrode 1552 applies voltage to the liquid crystal layer 1530.

The black matrix 1570 serves to divide the pixels and also serves to divide the subpixels within a single pixel. Further, the black matrix 1570 intercepts external light from entering the display panel 1500 to some extent. To this end, the black matrix 1570 is made of a photosensitive organic material including carbon black, titanium oxide, or like black pigment.

The over-coating layer 1580 covers and protects the black matrix 1570, and is provided for planarization of the bottom of the black matrix 1570. The over-coating layer 1580 may include an acrylic epoxy material.

Besides the foregoing elements, the display panel 1500 may additionally include a polarization layer for changing polarization properties of light, a protection film for protecting the display panel 1500 from the exterior, an anti-reflection film 1590 for preventing glare on the surface of the display panel 1500 caused by the external light, etc. as necessary.

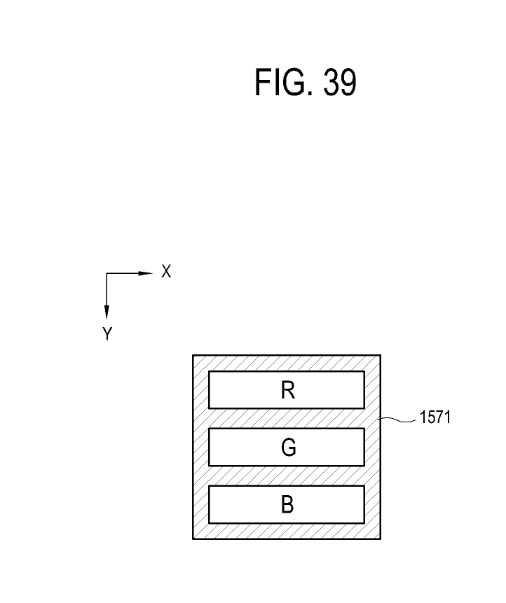

FIG. 39 illustrates a shape of a black matrix 1571 according to the fifteenth exemplary embodiment.

As shown in FIG. 39, the black matrix 1571 divides one pixel from another pixel on the X-Y plane, and further divides that one pixel into the plurality of subpixels R, G, and B respectively corresponding to the RGB colors. FIG. 39 shows only one black matrix 1571 corresponding to one single pixel, in which the one pixel may be variously divided into subpixels by the black matrix 1571.

The black matrix 1571 is formed with regard to all the pixels. That is, the black matrix 1571 is formed throughout the entire surface of the display panel. Thus, a manufacturer may place a marking on each black matrix 1571 in order to indicate the position of the corresponding pixel on the display panel. There are no limits to the shape, size, or design of the marking as long as the marking can indicate the position coordinates of the black matrix 1571. Because the marking is formed on the black matrix 1571, it does not interfere with the light passing through the subpixels R, G and B so that an image can be displayed on the display panel.

Thus, when an infrared ray is projected from a certain touch unit of the input device, it is reflected off the black matrix 1571 corresponding to the projection position. At this time, the shape of the marking formed on the black matrix 1571 is reflected back toward the touch unit. The touch unit can determine the coordinates of the touch position based on the received shape of the marking. The shape of the marking can be, for example, an optical pattern of dots, bars, geometric shapes, symbols, letters, numbers, etc.

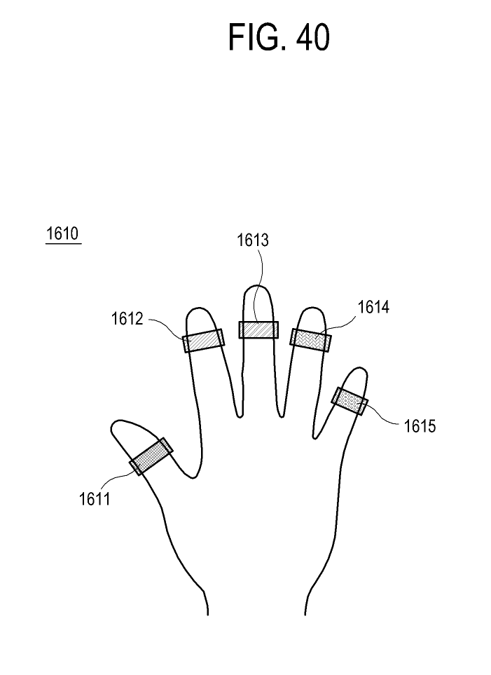

FIG. 40 illustrates an input device 1610 according to a sixteenth exemplary embodiment.

As shown in FIG. 40, the input device 1610 according to the sixteenth exemplary embodiment includes a plurality of touch units 1611, 1612, 1613, 1614, and 1615 respectively mounted to a user's fingers. In this exemplary embodiment, five touch units 1611, 1612, 1613, 1614, and 1615 are provided corresponding to the user's thumb and fingers. However, the touch units 1611, 1612, 1613, 1614, and 1615 need not correspond to all five fingers, and there may be provided two, three, or four touch units. In other words, there are no limits to the number of touch units 1611, 1612, 1613, 1614, and 1615.

The touch units 1611, 1612, 1613, 1614, and 1615 are each shaped like a ring to be put on the user's fingers. The touch units 1611, 1612, 1613, 1614, and 1615 include a first touch unit 1611 to be mounted to the user's thumb, a second touch unit 1612 to be mounted to the index finger, a third touch unit 1613 to be mounted to the middle finger, a fourth touch unit 1614 to be mounted to the ring finger, and a fifth touch unit 1615 to be mounted to the little finger.

In the foregoing exemplary embodiment, each touch unit of the input device internally includes a sensor or circuit structure related to the touch input. However, the touch units 1611, 1612, 1613, 1614, and 1615 in this embodiment are different in color so as to be visually distinguishable from one another. For example, the first touch unit 1611 may be red, the second touch unit 1612 may be yellow, the third touch unit 1613 may be green, the fourth touch unit 1614 may be blue, and the fifth touch unit 1615 may be black.

However, there are no limits to the selection of the foregoing colors as long as the touch units 1611, 1612, 1613, 1614, and 1615 are visually distinguishable from one another. For example, the touching units 1611, 1612, 1613, 1614, and 1615 may have different shades of gray, or may have different patterns, symbols, or markings printed on them.

Below, a principle of sensing the touch position by these touch units 1611, 1612, 1613, 1614 and 1615 will be described.

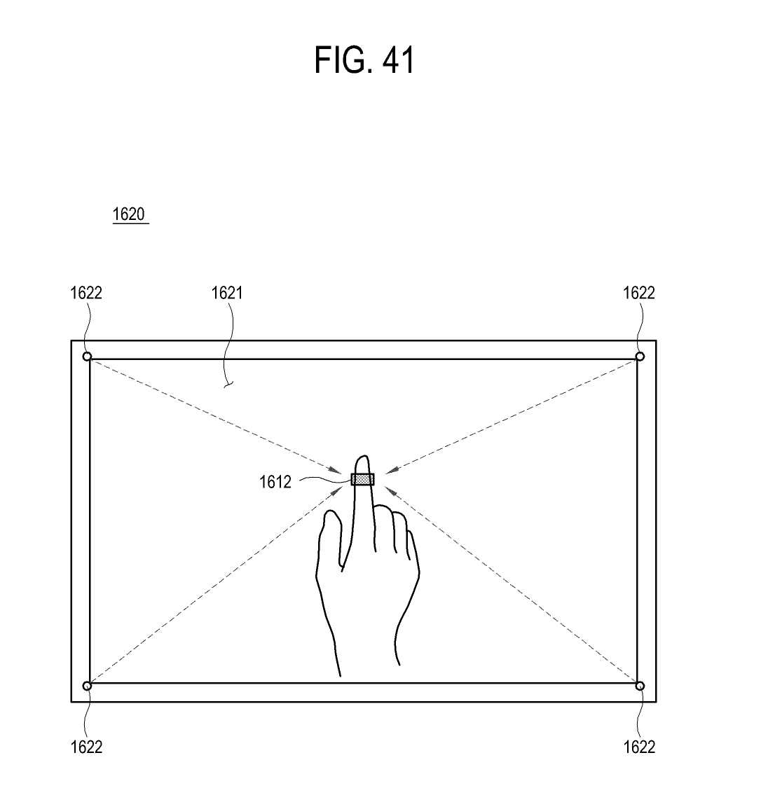

FIG. 41 illustrates a main device 1620 sensing a touch input of a second touch unit 1612 according to the sixteenth exemplary embodiment.

As shown in FIG. 41, the main device 1620 includes a display 1621, and a plurality of cameras 1622 provided in the vicinity of the display 1621 and sensing the touch unit 1612 touching the display 1621.

If a user touches a certain area of the display 1621 with her finger wearing the second touch unit 1612, the plurality of cameras 1622 arranged at four corners of the display 1621 photograph the touch input of the second touch unit 1612. Because the plurality of cameras 1622 are spaced from one another, the second touch unit 1612 is photographed at different positions.

In this exemplary embodiment, four cameras 1622 are arranged at places corresponding to the respective corners of the display 1621, but not limited thereto. Further, there are no limits to the number and placement of the cameras 1622. If a 2D camera is used, at least two cameras 1622 may be arranged being spaced from each other, and it is therefore possible to sense the position of the second touch unit 1612 on the display 1621. The method of determining the position coordinates may be achieved by trigonometry and the like well-known technique. Further, if a 3D camera is used, only one camera 1622 may be enough.

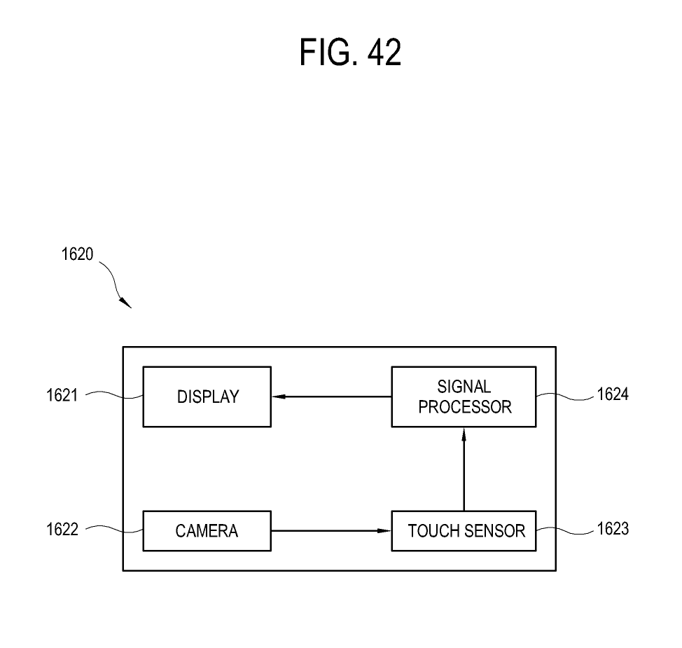

FIG. 42 is a block diagram of the main device 1620 according to the sixteenth exemplary embodiment. FIG. 42 shows only elements related to touch sensing in the main device 1620.

As shown in FIG. 42, the main device 1620 includes a display 1621, at least one camera 1622, a touch sensor 1623 for determining the touch input information about the position coordinates and the ID of the touch input based on the sensing result of the camera 1622, and a signal processor 1624 for executing a corresponding operation based on the touch input information from the touch sensor 1623. In this exemplary embodiment, the touch sensor 1623 and the signal processor 1624 are shown as separate elements, but the embodiment is not limited thereto. Alternatively, the signal processor 1624 may include the touch sensor 1623 without the need for an external touch sensor 1623 in accordance with disclosed methods.

The touch sensor 1623 receives and analyzes an image from the cameras 1622 and determines the position coordinates of the touch input and the ID of the touching unit that makes the touch input. The touch sensor 1623 generates the touch input information in accordance with the determination results and transmits the touch input information to the signal processor 1624.

The signal processor 1624 derives the ID of the touching unit from the touch input information and determines a function corresponding to the derived ID. The signal processor 1624 executes the determined function with respect to the position coordinates derived from the touch input information.

The determination of the ID of the touching unit by the touch sensor 1623 and the function corresponding to the ID of the touching unit by the signal processor 1624 may be achieved by searching the database previously set up. Below, such a database will be described.

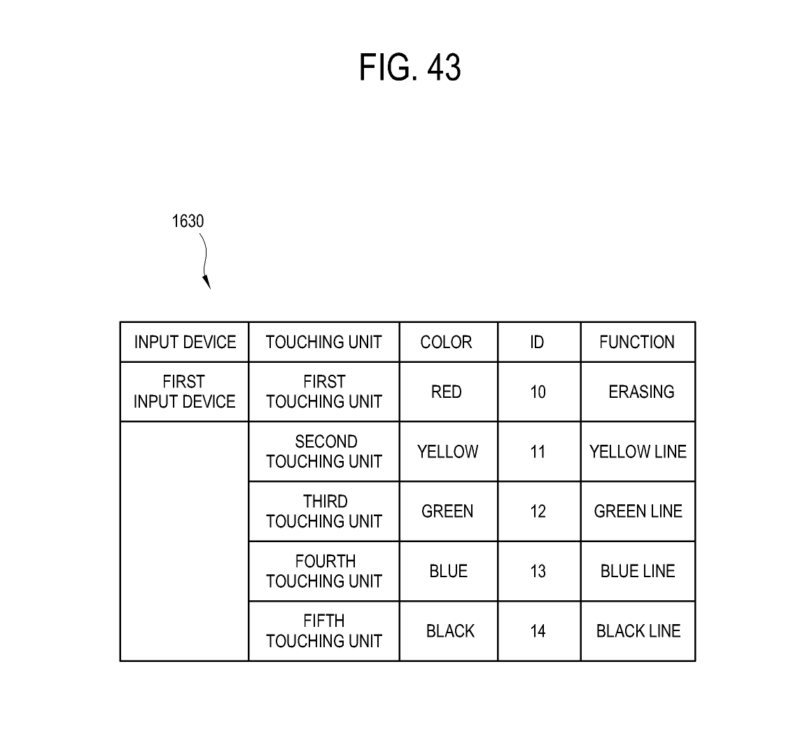

FIG. 43 illustrates a database 1630 according to the sixteenth exemplary embodiment.

As shown in FIG. 43, the database 1630 records the color of each touch unit, an ID corresponding to each color, and a function corresponding to each ID. For example, if the camera senses that the color of the touch unit is red, the touch sensor searches the database 1630 and assigns an ID of ‘10’ corresponding to red to the touch input. Likewise, if the camera senses that the color of the touch unit is black, the touch sensor assigns an ID of ‘14’ corresponding to black to the touch input.

The signal processor searches the database 1630 and determines that a function corresponding to the touch input having the ID of ‘10’ is erasing, thereby erasing an image corresponding to the position coordinates of the touch input. Likewise, the signal processor determines a function corresponding to the touch input having the ID of ‘14’ is a black line, thereby drawing a black line on the position coordinates of the touch input.

Thus, it is possible to make the touch units have their own functions in such a manner that the touch units are provided corresponding to colors and the camera senses the position and color of the touch unit.

Below, a method of sensing the display apparatus in this exemplary embodiment will be described.

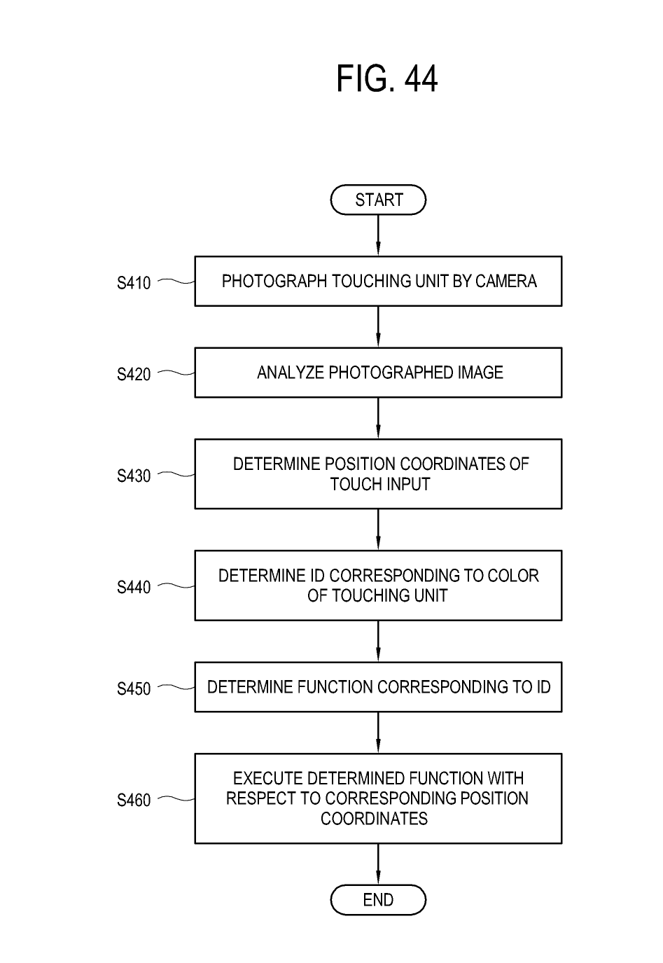

FIG. 44 is a flowchart for controlling a display apparatus according to the sixteenth exemplary embodiment.

As shown in FIG. 44, at operation S410, the display apparatus photographs, via the camera, the touch unit generating the touch input.

At operation S420, the display apparatus analyzes an image photographed by the touch unit.

At operation S430, the display apparatus determines the position coordinates of the touch input in accordance with the analysis results.

At operation S440, the display apparatus determines the ID corresponding to the color of the touch unit in accordance with the analysis results.

At operation S450, the display apparatus determines a function corresponding to the ID.

At operation S460, the display apparatus executes the determined function at the position coordinates.

The method of assigning the characteristic functions to the touch units, and executing the previously assigned function by determining the touch unit making the touch input may be implemented in various applications. In particular, if a video game application supporting the touch input is executed on a device that supports multi-touch, it is possible to variously extend the functions through multi-touch.

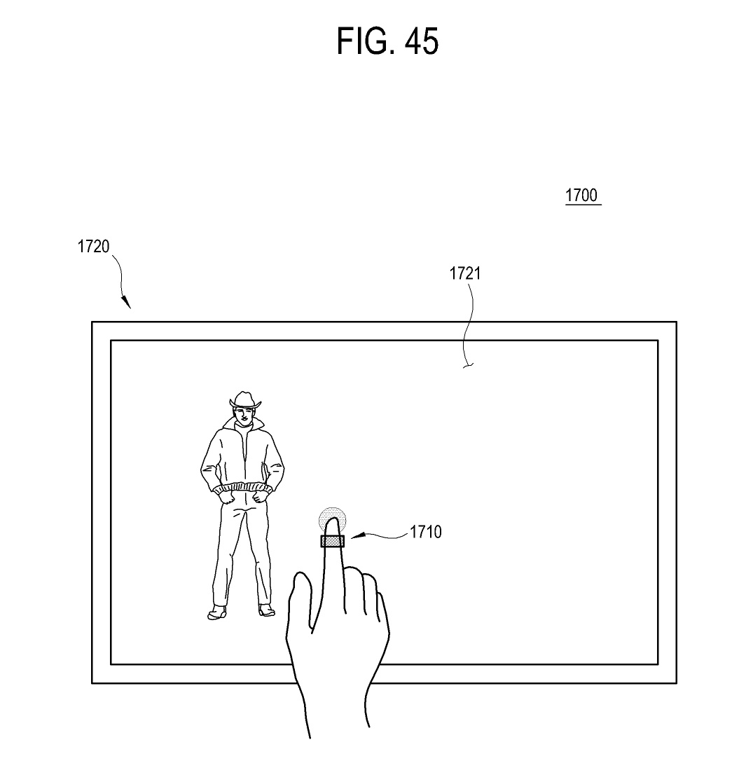

FIG. 45 illustrates a video game application being executed in a display apparatus 1700 according to the seventeenth exemplary embodiment.

As shown in FIG. 45, the display apparatus 1700 according to the seventeenth exemplary embodiment includes a main device 1720 for displaying an image of a game application, and an input device 1710 for allowing a user to control the image. The elements and operations of the main device 1720 and the input device 1710 may be substantially similar to those of the foregoing exemplary embodiment, and thus detailed descriptions thereof will be omitted.

The main device 1720 executes the game application on the operating system, so that a game image can be displayed on a device 1721. If the game image contains a human character, the game application controls the human character to move within the image in response to the touch input. To this end, the game application has a database where operations are respectively matched to the IDs of the touch input.

If a user touches the device 1721 with a certain touch unit of the input device 1710, the game application performs an operation assigned, in the database, to the touch unit making the touch input.

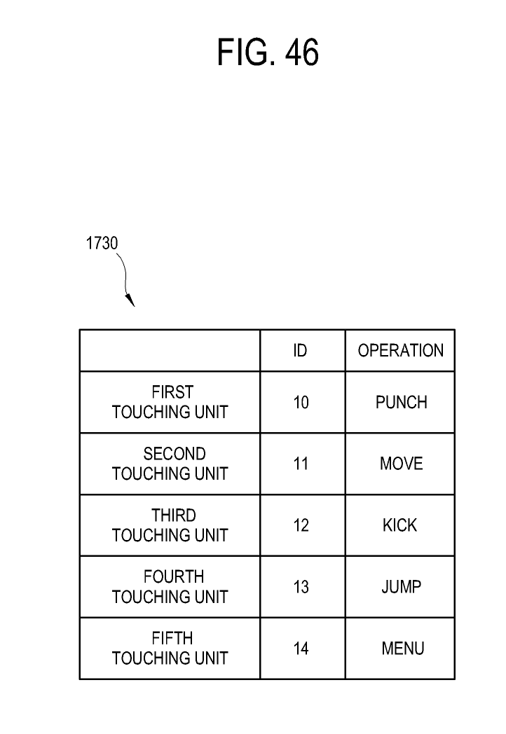

FIG. 46 illustrates a database 1730 according to the seventeenth exemplary embodiment.

As shown in FIG. 46, the database 1730 records IDs respectively assigned to a plurality of touch units of the input device, and operations respectively assigned to the IDs. For example, if the touch input is caused by the first touch unit, an ID of ‘10’ is assigned to this touch input. Further, if the touch input is caused by the second touch unit, an ID of ‘11’ is assigned to this touch input.

The game application searches the database 1730 for the ID of ‘10’ with respect to the touch input, and thus determines that the corresponding operation is a punch, thereby making a human character throw a punch within the game image. Likewise, if the game application determines that the touch input having the ID of ‘11’ corresponds to an operation of move, the human character moves within the game image in response to the touch input.

Thus, there is provided an application that is convenient for a user to make an input through the database 1730 where individual operations are assigned to the respective touch units.

This embodiment discloses the operations based only on the single touch, but the embodiment is not limited thereto. Alternatively, the operations may be extended further into cases involving multi-touch.

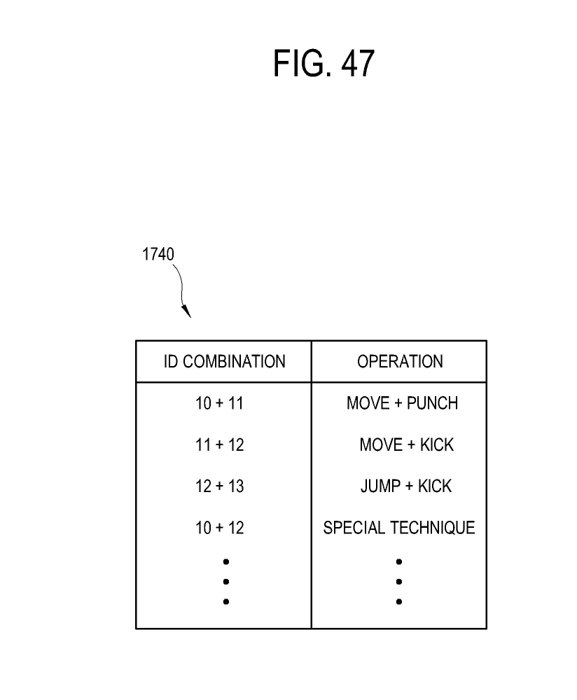

FIG. 47 illustrates a database 1740 where combination operations are assigned to multi-touch inputs according to the seventeenth exemplary embodiment.

As shown in FIG. 47, the database 1740 records an operation assigned to combinations of IDs of respective touch inputs in consideration of multi-touch. Such an operation may be executed in such a manner that the individual operations corresponding to respective the IDs are performed simultaneously or a new operation corresponding to the combination of inputs is performed instead of performing the individual operations.

For example, if two concurrent touch inputs occur and their IDs are respectively ‘10’ and ‘11,’ the game application searches the database 1740 and thus controls a human character to move and throw a punch within the game image. Likewise, if two touch inputs occur and their IDs are respectively ‘11’ and ‘12,’ the game application controls a human character to move and give a kick within the game image. Further, if two touch inputs occur and their IDs are respectively ‘12’ and ‘13,’ the game application controls a human character to jump and give a kick within the game image. The foregoing operations refer to combinations of operations assigned to the IDs.

Alternatively, if two concurrent touch inputs occur and their IDs are respectively ‘10’ and ‘12,’ the game application may control a human character to perform a special move instead of giving a punch or a kick or simultaneously giving both the punch and the kick within the game image. That is, this operation refers to a new operation different from those operations associated with IDs ‘10’ and ‘12.’

Moreover, a plurality of users may generate touch inputs with their own input devices concurrently with respect to one image.

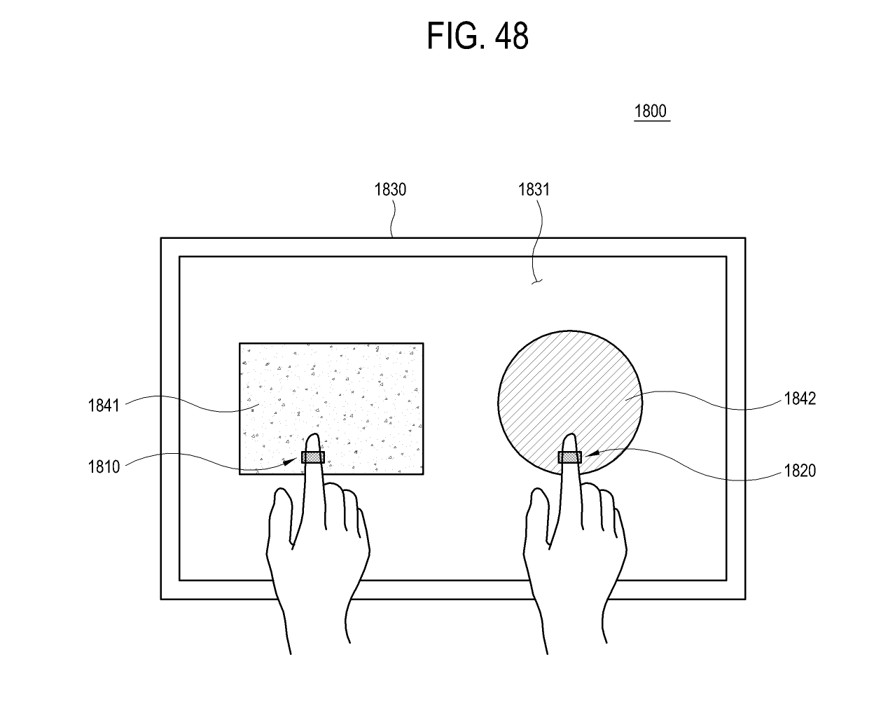

FIG. 48 illustrates an application being executed in a display apparatus 1800 according to an eighteenth exemplary embodiment.

As shown in FIG. 48, the display apparatus 1800 according to the eighteenth exemplary embodiment includes a main device 1830 for displaying an image of an application, and a plurality of input devices 1810 and 1820 allowing more than one user to control the image simultaneously. The main device 1830 and the input devices 1810 and 1820 have structures and operations similar to those of the foregoing exemplary embodiments, and thus duplicative descriptions thereof will be omitted.

In the main device 1830, an application supporting touch input displays an image for interaction with the input device on a display 1831. This image contains a plurality of objects 1841 and 1842 provided for controlling operations in response to the touch inputs. With this, suppose that a first user controls a first object 1841 with a first input device 1810, and a second user controls a second object 1842 with a second input device 1820.

The touch sensor of the main device 1830 assigns previously designated IDs to the touch input of the first input device 1810 and the touch input of the second input device 1820, respectively. For example, the touch sensor may assign an ID of ‘10’ to the touch input caused by a certain touch unit of the first input device 1810, and assign an ID of ‘22’ to the touch input caused by a certain touch unit of the second input device 1820.

The application determines that the touch input is caused by the first input device 1810 if the ID is ‘10,’ and determines that the touch input is caused by the second input device 1820 if the ID is ‘20.’ If it is determined that the touch input caused by the first input device 1810 is performed on the first object 1841, the application performs an operation corresponding to the first object 1841 at the position coordinates where the touch input occurs with respect to the first object 1841. However, if it is determined that the touch input caused by the first input device 1810 is performed on the second object 1842, the application does not perform an operation corresponding to the second object 1842 because the second object 1842 is provided for interaction with the second input device 1820.

On the other hand, if it is determined that the touch input caused by the second input device 1820 is performed on the second object 1842, the application performs an operation corresponding to the second object 1842. However, if it is determined that the touch input caused by the second input device 1820 is performed on the first object 1841, the application does not perform an operation corresponding to the first object 1841 because the first object 1841 is provided for interaction with the first input device 1810.

Therefore, the first object 1841 is prevented from performing a corresponding operation in response to the touch input caused by a second user, even if the second user generates the touch input to the first object 1841.

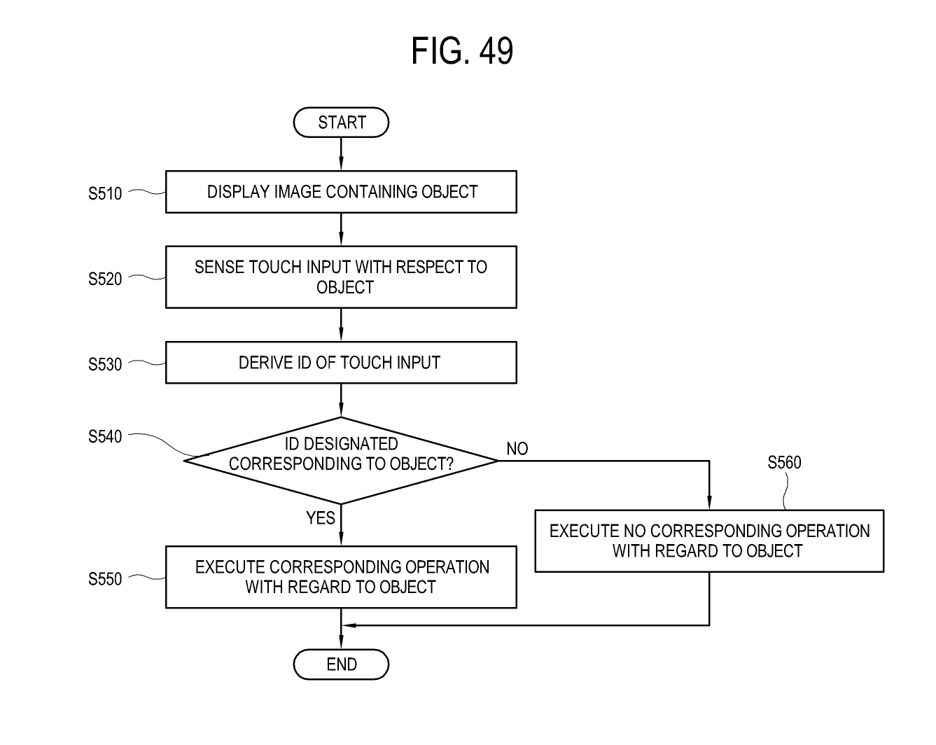

FIG. 49 is a flowchart for controlling the display apparatus according to the eighteenth exemplary embodiment.

As shown in FIG. 49, at operation S510, the display apparatus displays an image. The image contains one or more objects prepared to operate in response to only a specially designated input device or touch unit.

At operation S520, the display apparatus senses the touch input to the object.

At operation S530, the display apparatus derives the ID of the touch input.

At operation S540, the display apparatus determines whether the derived ID is designated for the object. That is, the display apparatus determines whether the derived ID is associated with the object.

If it is determined that the derived ID is designated corresponding to the object, at operation S550, the display apparatus executes the corresponding operation with respect to the object. On the other hand, if it is determined that the derived ID is not designated corresponding to the object, at operation S560, the display apparatus does not execute the corresponding operation with respect to the object.

Thus, the display apparatus in this exemplary embodiment makes an object to interact only with a touch input of a previously designated ID when the object is provided for interaction with a certain touch input.

In this manner, if the input devices or the touch units are distinguishable among one another, the display apparatus stores only a history of touch inputs caused by a certain input device or touch unit, and recalls the stored history in the future.

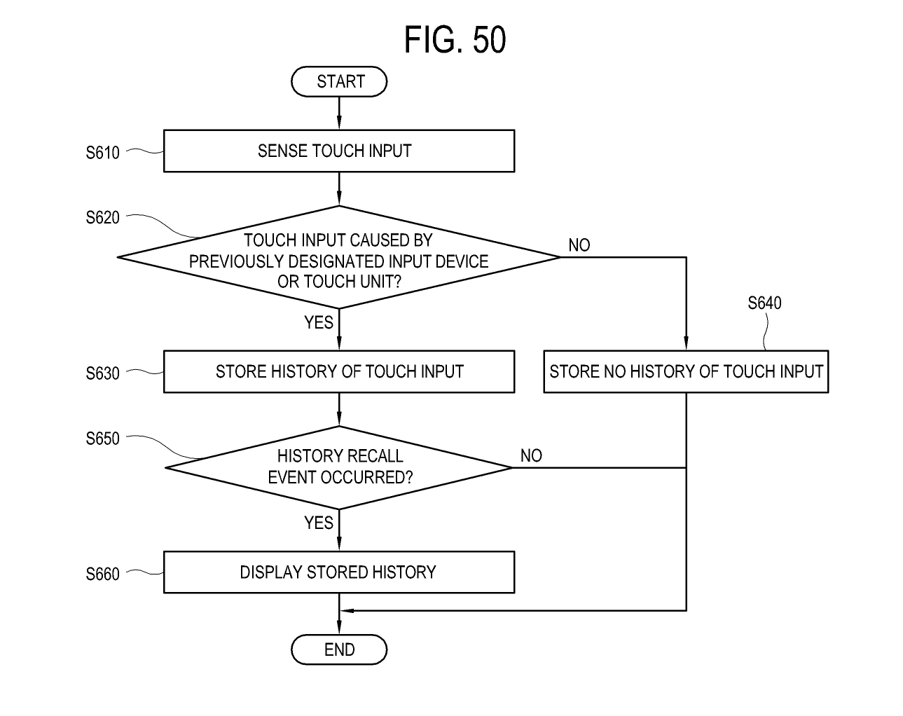

FIG. 50 is a flowchart for controlling a display apparatus according to a nineteenth exemplary embodiment.

As shown in FIG. 50, at operation S610, the display apparatus senses a touch input.

At operation S620, the display apparatus determines whether the touch input is caused by the previously designated input device or touch unit.

If it is determined that the touch input is caused by the previously designated input device or touch unit, at operation S630, the display apparatus stores a history of touch inputs. The history may include, for example, a written word or a picture drawn by the touch input. On the other hand, if it is determined that the touch input is not caused by the previously designated input device or touch unit, at operation S640, the display apparatus does not store a history of touch input.

At operation S650, the display apparatus determines whether an event of recalling the history occurred. If this event occurred, the display apparatus displays the previously stored history. For example, the display apparatus may store words written with the input device or the touch unit and display the stored words in the future.

In the foregoing exemplary embodiments, the touch sensor for sensing the touch input of the input device is installed in the main device, but the display apparatus is not limited to this structure.

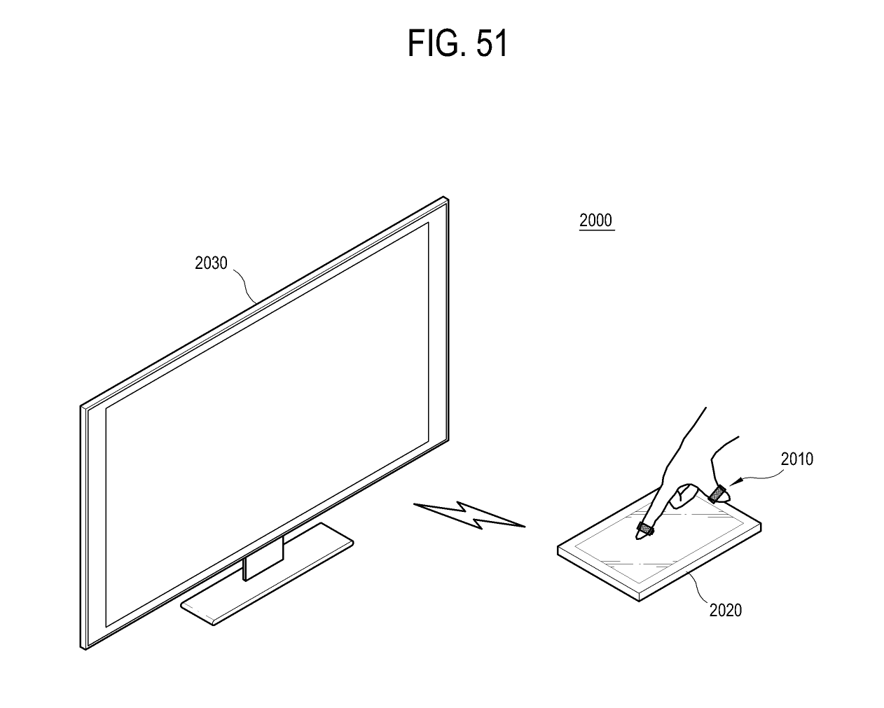

FIG. 51 illustrates a display apparatus 2000 according to a twentieth exemplary embodiment.

As shown in FIG. 51, the display apparatus 2000 according to the twentieth exemplary embodiment includes an input device 2010 for making a touch input, a touch sensing device 2020 for sensing the touch input of the input device 2010, and a main device 2030 for displaying an image in accordance with touch sense results of the touch sensing device 2020.

In the foregoing exemplary embodiments, the touch sensor for sensing the touch input of the input device 2010 and deriving the position coordinates and ID of the touch input is installed in the main device, and a user touches the display of the main device.

However, in this exemplary embodiment, the touch sensing device 2020 separate from the main device 2030 serves as the touch sensor. Therefore, a user touches a touch surface provided in the touch sensing 2020 instead of the display of the main device 2030. The touch sensing device 2020 communicates with the main device 2030 by a wire or wirelessly, and thus sends touch input information to the main device 2030.

As described above, the disclosed embodiments may be achieved by various structures and methods.

In the foregoing exemplary embodiments, the display apparatus determines the ID of the touch unit generating the touch input among the plurality of touch units, and searches the previously stored database for the operation set corresponding to the determined ID. This database is previously set and stored in the display apparatus. When an application supporting the touch input is executed in the display apparatus, the application searches the database for the operation corresponding to the ID of the touch unit, and caries out the operation.

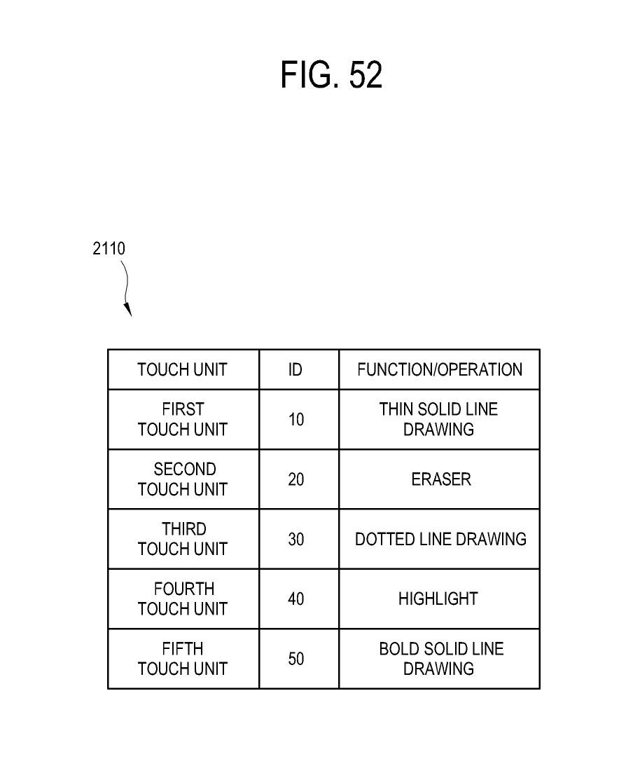

FIG. 52 illustrates a default database 2110 stored in the display apparatus according to a twenty-first exemplary embodiment.

As shown in FIG. 52, one touch unit among the plurality of touch units makes a touch input, and the ID of this touch unit is sent to an application. Thus, the application searches the database 2110 for the received ID of the touch unit, and determines an operation corresponding to the touch unit.

For example, when a first touch unit among the plurality of touch units makes a touch input, an ID of ‘10’ is transmitted from the first touch unit to the application. Based on the database 2110, the application determines that the operation corresponding to the ID of ‘10’ is a thin solid line, and performs an operation of drawing the thin solid line along the position of the touch input. In addition, if a second touch unit among the plurality of touch units makes a touch input, an ID of ‘20’ is transmitted from the second touch unit to the application. Based on the database 2110, the application determines that the operation corresponding to the ID of ‘20’ is an eraser, and performs an erasing operation along the position of the touch input.

Such operations designated in the database 2110 are previously set and stored in the display apparatus, and from the database 2110 when the application is executed. In addition, the display apparatus allows a user to adjust the operations designated in the database 2110.

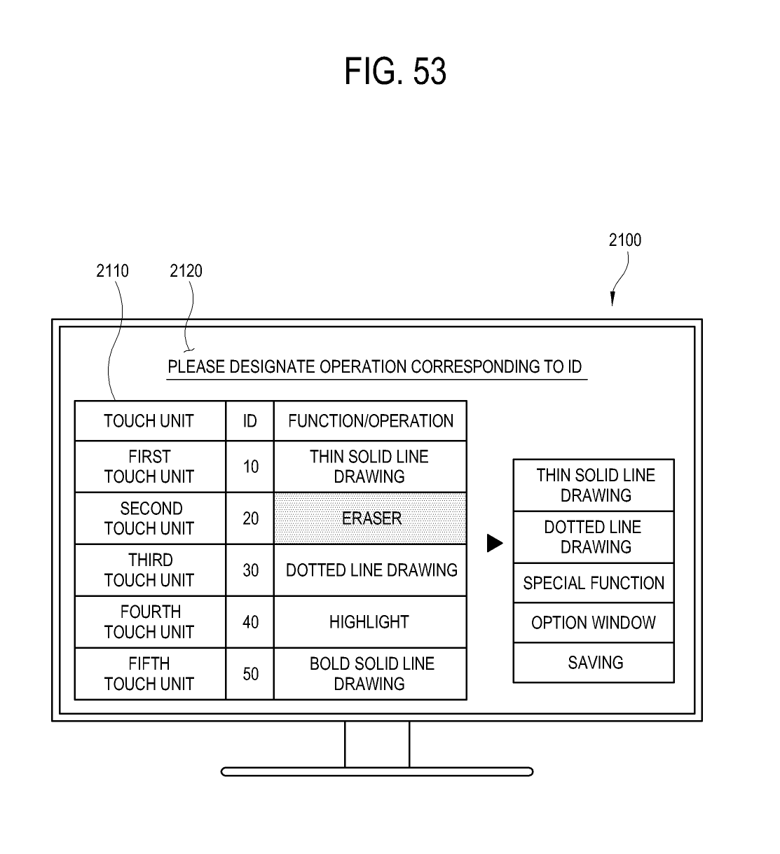

FIG. 53 illustrates a user interface (UI) 2120, in which operations designated in the database 2110 is changeable, displayed on the display apparatus 2100 according to the twenty-first exemplary embodiment.

As shown in FIG. 53, the display apparatus 2100 displays the UI 2120, in which the content of the database 2110 is changeable, in response to a preset input of a user. The UI 2120 shows records of the database 2110, and allows a user to select and reassign the function or operations matched to the IDs of the touch units. Options for the operations selectable by a user are selected among available options supported by the application.

For example, if the default operation corresponding to the second touch unit is the eraser, a user may replace the eraser with another operation supported in the application through the UI 2120. The operation to replace the eraser may include a thin solid line, a dotted line, and like operations already assigned to other touch units except for the eraser, or may include a special function, an option window, saving, and like operations not assigned to any touch unit.

If a user selects the operation already designated for another touch unit, the selected operation is reassigned to the second touch unit and released from the originally assigned touch unit. For example, if a user designates a thin solid line as the operation corresponding to the second touch unit even though the fine solid line has already been assigned to the first touch unit, the display apparatus 2100 changes the operation corresponding to the second touch unit into the thin solid line and changes the first touch unit not to correspond to any operation. Thus, the first touch unit is in a state to be assigned to a new operation by a user.

On the other hand, the operations already assigned to the other touch units may be not selectable. For example, among the options selectable for the second touch unit, a thin solid line, a dotted line, a highlight, a bold solid line, and like operations, which already have been assigned to the other touch units, may not be available to a user for selection.

The database 2110 modified through the UI 2120 may be permanently stored in the display apparatus 2100 and accessed whenever the application is executed. Alternatively, the database 2110 modified through the UI 2120 may be stored only when the application is being executed, and deleted when the application is terminated.

In the former case, the display apparatus 2100 stores changes made through the UI 2120, and calls the database 2110 reflecting the changes, when the application is executed in the future. The changes may be stored according to users' accounts. For example, changes in the database 2110 by a first user are applied only when the first user uses the application in the future, and not applied when another user uses the application.

In the latter case, the display apparatus 2100 temporarily stores the changes made through the UI 2120, and applies the changes only while the application is being executed. When the application is terminated, the changes are discarded and not stored. If the application is executed in the future, the database 2110 in which the changes are not reflected is called.

Accordingly, the operations to be respectively assigned to the touch units are easily adjustable in accordance with users' intention.

As described above, the display apparatus according to the foregoing exemplary embodiments includes the display for displaying an image; the sensor for sensing a touch input on a touch surface, caused by at least one among a plurality of touch units, which correspond to a plurality of preset operations to be performed in the display apparatus and are mounted to a plurality of fingers of a user; and at least one processor for determining the touch unit mounted to the finger making the touch input sensed by the sensor among the plurality of touch units. This processor executes the operation corresponding to the determined touch unit among the plurality of operations with respect to the touch input.

Further, the present inventive concept is not always achieved in such a manner that the touch unit touches or contacts the touch surface. Alternatively, the touch unit may make a contactless input. The display apparatus in this exemplary embodiment may include a display for displaying an image; a sensor for sensing an input operation on a preset input surface, caused by at least one among a plurality of input units mounted to a plurality of fingers of a user and corresponding to a plurality of preset functions to be performed in the display apparatus; and at least one processor for determining the input unit mounted to the fingers making the input operation sensed by the sensor among the plurality of input units. This processor executes a function corresponding to the determined input unit among the plurality of designated functions with respect to the input operation.

The methods according to the foregoing exemplary embodiments may be achieved in the form of a program command that can be implemented in various computers, and recorded in a computer-readable medium. Such a computer-readable medium may store a program command, a data file, a data structure or the like, or combination thereof. For example, the computer-readable medium may be a volatile or nonvolatile storage such as a read-only memory (ROM) or the like, regardless of whether it is erasable or rewritable, for example, a random access memory (RAM), a memory chip, a device or integrated circuit (IC) or like memory, or an optically or magnetically recordable machine (e.g., a computer)-readable storage medium, for example, a compact disc (CD), a digital versatile disc (DVD), a magnetic disk, a magnetic tape or the like. It will be appreciated that a memory, which can be included in a mobile terminal, is an example of the machine-readable storage medium suitable for storing a program having instructions for realizing the exemplary embodiments. The program command recorded in this storage medium may be specially designed and constructed according to the exemplary embodiments, or may be publicly known and available to those skilled in the art of computer software.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display configured to display an image;
a sensor configured to sense a touch input on a touch surface, the touch input being performed by at least one touch unit among a plurality of touch units mounted on a user, the plurality of touch units corresponding to a plurality of preset operations to be performed in the display apparatus; and
at least one processor configured to:
determine the at least one touch unit that performs the touch input sensed by the sensor, among the plurality of touch units, and
execute an operation which corresponds to the determined at least one touch unit, among the plurality of preset operations, based on the touch input.

2. The display apparatus according to claim 1, wherein the plurality of touch units are provided to generate a plurality of electric signals, and
the at least one processor determines the at least one touch unit performing the touch input by assigning an identification (ID) to the touch input according to a level of an electric signal sensed by the sensor.

3. The display apparatus according to claim 2, wherein the plurality of touch units comprise resonant coils for generating electromagnetic fields having different resonant frequencies, and
the at least one processor assigns the ID to the touch input, the ID being designated according to a resonant frequency corresponding to the touch input.

4. The display apparatus according to claim 2, wherein the plurality of touch units comprising capacitors having different capacitances,
the sensor comprises a plurality of transmitting wires and a plurality of receiving wires, the plurality of transmitting wires intersecting with the plurality of receiving wires, and
the sensor applies a touch sensing voltage to the plurality of transmitting wires, and senses the touch input based on a voltage change caused by the touch input and output from the plurality of receiving wires.

5. The display apparatus according to claim 4, wherein the at least one processor assigns the ID, which is designated according to an output voltage level drop, to the touch input.

6. The display apparatus according to claim 2, wherein a marking, indicating position coordinates on the touch surface, is formed on the touch surface, and
each touch unit of the plurality of touch units comprises an infrared sensor for sensing the marking on the touch surface, and a communicator for sending to the at least one processor the position coordinates corresponding to the sensed marking.

7. The display apparatus according to claim 6, wherein the communicator transmits an identification (ID) number of the communicator together with the position coordinates to the at least one processor, and
the at least one processor assigns an ID, which is designated according to the ID number, to the touch input.

8. The display apparatus according to claim 7, wherein the communicator comprises a Bluetooth communication module, and
the ID number comprises a media access control (MAC) address of the Bluetooth communication module.

9. The display apparatus according to claim 6, wherein the touch surface is formed on the display, and
the marking is formed on a black matrix, which divides pixels in the display.

10. The display apparatus according to claim 1, wherein the plurality of touch units have respective colors that are different from one another,
the sensor comprises a camera for sensing the respective colors of the plurality of touch units and respective positions of the plurality of touch units on the touch surface, and
the at least one processor determines the at least one touch unit performing the touch input by assigning an identification (ID), which is designated according to a corresponding color sensed by the camera, to the touch input.

11. The display apparatus according to claim 1, wherein the at least one processor sends touch input information, which comprises information about position coordinates of the touch input and information about determination of the at least one touch unit performing the touch input among the plurality of touch units, to an application while the application for performing an operation corresponding to the touch input is being executed on an operating system, and
the touch input information complies with standards supported by the operating system.

12. The display apparatus according to claim 11, wherein the information about the determination of the at least one touch unit is recorded in one of data fields unrelated to the execution of the application, among a plurality of data fields according to the standards.

13. The display apparatus according to claim 12, wherein the information about the determination of the at least one touch unit is recorded in a data field associated with azimuth among the plurality of data fields according to the standards.

14. The display apparatus according to claim 11, wherein the information about the determination of the at least one touch unit is recorded in a new data field added to the plurality of data fields according to the standards.

15. The display apparatus according to claim 2, wherein the at least one touch unit comprises:
a housing configured to be placed on a finger of the user; and
a signal generator configured to be accommodated in the housing and generate the electric signal.

16. The display apparatus according to claim 15, wherein the housing is shaped like a ring or a thimble.

17. The display apparatus according to claim 2, wherein:
the plurality of touch units are formed on areas corresponding to a finger of the user in a base shaped like a glove to be worn by the user, and
the display apparatus further comprises a circuit element installed in a certain area of the base and driving each touch unit to generate the electric signal.

18. A method of controlling a display apparatus, the method comprising:
sensing a touch input on a touch surface, the touch input caused by at least one touch unit among a plurality of touch units mounted on a user, the plurality of touch units corresponding to a plurality of preset operations to be performed in the display apparatus;
determining the at least one touch unit that performs the touch input, among the plurality of touch units; and
executing an operation, which corresponds to the determined at least one touch unit, among the plurality of preset operations with respect to the touch input.

19. A display apparatus comprising:
a display configured to display an image;
a sensor configured to sense an input operation on a preset input surface, the input operation being performed by at least one input unit among a plurality of input units corresponding to a plurality of preset functions to be performed in the display apparatus in a state where the plurality of input units are mounted on a user; and
at least one processor configured to:
determine the at least one input unit, which performs the input operation sensed by the sensor, among the plurality of input units, and
to execute a function that corresponds to the determined at least one input unit, among the plurality of preset functions with respect to the input operation.

20. The display apparatus according to claim 19, wherein the plurality of input units are provided to be respectively mounted to a plurality of fingers of the user.
